(19) United States
(12) Patent Application Publication
(10) Pub. No.: US 2026/0129472 A1
(43) Pub. Date: May 7, 2026

(54) DATA OFFLOAD FROM A RELAY DEVICE

(71) Applicant: QUALCOMM Incorporated, San Diego, CA (US)

(72) Inventors: Chun-Hsiang CHIU, Yonghe Dist. (TW); Jen-Chun CHANG, New Taipei City (TW); Wen-Hsin HSIA, New Taipei City (TW); Sheng-Chih WANG, New Taipei City (TW); Kuhn-Chang LIN, Chiayi City (TW); Chenghsin LIN, New Taipei City (TW); Kai-Chun CHENG, Taipei City (TW); Chung Wei LIN, Taipei City (TW); Yu-Chieh HUANG, Taipei City (TW)

(21) Appl. No.: 18/935,218

(22) Filed: Nov. 1, 2024

(51) Int. Cl. H04W 24/02; H04W 8/22; H04W 74/0833; H04W 76/10

(52) U.S. Cl. CPC H04W 24/02; H04W 8/22; H04W 74/0833; H04W 76/10

(57) ABSTRACT

Various aspects of the present disclosure generally relate to wireless communication. A network node and a client device may establish a direct wireless wide area network (WWAN) link that leverages WWAN access authorization associated with a relay device. Some aspects more specifically relate to the relay device transmitting a request to the network node to configure a sharing cell group for direct WWAN communications between the network node and the client device in accordance with an identifier module profile of the relay device, where the identifier module profile extends WWAN authorization to the client device. In some aspects, the client device, the relay device, and/or the network node may configure one or more parameters associated with the sharing cell group, such as an active time duration, a volume of data threshold for the sharing cell group, a data rate of the sharing cell group, or a cool down timer.

### FIELD OF THE DISCLOSURE

Aspects of the present disclosure generally relate to wireless communication and specifically relate to techniques, apparatuses, and methods associated with data offload from a relay device.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some wireless communication networks, data connectivity for one or more wireless devices may be facilitated through an intermediary device that is enabled to communicate over multiple radio access technologies (RATs). For example, a relay device, which may be capable of accessing a wireless wide area network (WWAN), may extend network connectivity to one or more client devices that lack direct access to the WWAN (such as a client device without a subscription or other authorization to directly access the WWAN). The relay device may extend such network connectivity through wireless local area network (WLAN) technologies, where the relay device acts as an intermediary, bridging the gap between a WWAN RAT (for example, 4G Long Term Evolution (LTE) or 5G New Radio (NR), among other examples) and a WLAN RAT (for example, an IEEE 802.11 wireless communication protocol, commonly known as “Wi-Fi”). For example, the relay device may communicate directly with a network node via a WWAN link, and may communicate directly with a client device via a WLAN link. Therefore, the relay device may operate in accordance with WWAN and WLAN capabilities to create a multiple RAT (multi-RAT) access bridge, where the client device communicates with the relay device to transmit and/or receive data via the WLAN link, and the relay device communicates with the network node via the WWAN link to relay the transmitted and/or received data on behalf of the client device.

### SUMMARY

Some aspects described herein relate to a client wireless communication device for wireless communication. The client wireless communication device may include a processing system that includes one or more processors and one or more memories coupled with the one or more processors. The processing system may be configured to cause the client wireless communication device to transmit, to a relay wireless communication device and via a first radio access technology (RAT), information indicating one or more capabilities associated with a second RAT. The processing system may be configured to cause the client wireless communication device to receive, from the relay wireless communication device and via the first RAT, configuration information for a cell group associated with a network node, the configuration information being associated with the one or more capabilities associated with the second RAT. The processing system may be configured to cause the client

wireless communication device to transmit, to the network node and via the second RAT, a request to establish a connection with the network node for the second RAT in accordance with the configuration information.

Some aspects described herein relate to a relay wireless communication device for wireless communication. The relay wireless communication device may include a processing system that includes one or more processors and one or more memories coupled with the one or more processors. The processing system may be configured to cause the relay wireless communication device to receive, from a client wireless communication device and via a first RAT, information indicating one or more capabilities associated with a second RAT. The processing system may be configured to cause the relay wireless communication device to transmit, to a network node and via the second RAT, a cell group request indicating a request for the network node to establish a cell group for connection between the client wireless communication device and the network node for the second RAT, the cell group request including the one or more capabilities associated with the second RAT. The processing system may be configured to cause the relay wireless communication device to receive, from the network node and via the second RAT, configuration information for the cell group, the configuration information being associated with the one or more capabilities associated with the second RAT. The processing system may be configured to cause the relay wireless communication device to transmit, to the client wireless communication device and via the first RAT, the configuration information for the cell group.

Some aspects described herein relate to a network node for wireless communication. The network node may include a processing system that includes one or more processors and one or more memories coupled with the one or more processors. The processing system may be configured to cause the network node to receive, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT. The processing system may be configured to cause the network node to transmit, to the relay wireless communication device and via the second RAT, configuration information for the cell group, the configuration information being associated with the one or more capabilities associated with the second RAT. The processing system may be configured to cause the network node to receive, from the client wireless communication device and via the second RAT, a request to establish a connection with the network node for the second RAT in accordance with the configuration information.

Some aspects described herein relate to a method of wireless communication by a client wireless communication device. The method may include transmitting, to a relay wireless communication device and via a first RAT, information indicating one or more capabilities associated with a second RAT. The method may include receiving, from the relay wireless communication device and via the first RAT, configuration information for a cell group associated with a network node, the configuration information being associated with the one or more capabilities associated with the second RAT. The method may include transmitting, to the network node and via the second RAT, a request to establish a connection with the network node for the second RAT in accordance with the configuration information.

Some aspects described herein relate to a method of wireless communication by a relay wireless communication device. The method may include receiving, from a client wireless communication device and via a first RAT, information indicating one or more capabilities associated with a second RAT. The method may include transmitting, to a network node and via the second RAT, a cell group request indicating a request for the network node to establish a cell group for connection between the client wireless communication device and the network node for the second RAT, the cell group request including the one or more capabilities associated with the second RAT. The method may include receiving, from the network node and via the second RAT, configuration information for the cell group, the configuration information being associated with the one or more capabilities associated with the second RAT. The method may include transmitting, to the client wireless communication device and via the first RAT, the configuration information for the cell group.

Some aspects described herein relate to a method of wireless communication by a network node. The method may include receiving, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT. The method may include transmitting, to the relay wireless communication device and via the second RAT, configuration information for the cell group, the configuration information being associated with the one or more capabilities associated with the second RAT. The method may include receiving, from the client wireless communication device and via the second RAT, a request to establish a connection with the network node for the second RAT in accordance with the configuration information.

Some aspects described herein relate to an apparatus for wireless communication. The apparatus may include means for transmitting, to a relay wireless communication device and via a first RAT, information indicating one or more capabilities associated with a second RAT. The apparatus may include means for receiving, from the relay wireless communication device and via the first RAT, configuration information for a cell group associated with a network node, the configuration information being associated with the one or more capabilities associated with the second RAT. The apparatus may include means for transmitting, to the network node and via the second RAT, a request to establish a connection with the network node for the second RAT in accordance with the configuration information.

Some aspects described herein relate to an apparatus for wireless communication. The apparatus may include means for receiving, from a client wireless communication device and via a first RAT, information indicating one or more capabilities associated with a second RAT. The apparatus may include means for transmitting, to a network node and via the second RAT, a cell group request indicating a request for the network node to establish a cell group for connection between the client wireless communication device and the network node for the second RAT, the cell group request including the one or more capabilities associated with the second RAT. The apparatus may include means for receiving, from the network node and via the second RAT, configuration information for the cell group, the configuration information being associated with the one or more capabilities associated with the second RAT. The apparatus may include means for transmitting, to the client wireless communication device and via the first RAT, the configuration information for the cell group.

Some aspects described herein relate to an apparatus for wireless communication. The apparatus may include means for receiving, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT. The apparatus may include means for transmitting, to the relay wireless communication device and via the second RAT, configuration information for the cell group, the configuration information being associated with the one or more capabilities associated with the second RAT. The apparatus may include means for receiving, from the client wireless communication device and via the second RAT, a request to establish a connection with the network node for the second RAT in accordance with the configuration information.

Some aspects described herein relate to a non-transitory computer-readable medium that stores a set of instructions for wireless communication by a client wireless communication device. The set of instructions, when executed by one or more processors of the client wireless communication device, may cause the client wireless communication device to transmit, to a relay wireless communication device and via a first RAT, information indicating one or more capabilities associated with a second RAT. The set of instructions, when executed by one or more processors of the client wireless communication device, may cause the client wireless communication device to receive, from the relay wireless communication device and via the first RAT, configuration information for a cell group associated with a network node, the configuration information being associated with the one or more capabilities associated with the second RAT. The set of instructions, when executed by one or more processors of the client wireless communication device, may cause the client wireless communication device to transmit, to the network node and via the second RAT, a request to establish a connection with the network node for the second RAT in accordance with the configuration information.

Some aspects described herein relate to a non-transitory computer-readable medium that stores a set of instructions for wireless communication by a relay wireless communication device. The set of instructions, when executed by one or more processors of the relay wireless communication device, may cause the relay wireless communication device to receive, from a client wireless communication device and via a first RAT, information indicating one or more capabilities associated with a second RAT. The set of instructions, when executed by one or more processors of the relay wireless communication device, may cause the relay wireless communication device to transmit, to a network node and via the second RAT, a cell group request indicating a request for the network node to establish a cell group for connection between the client

wireless communication device and the network node for the second RAT, the cell group request including the one or more capabilities associated with the second RAT. The set of instructions, when executed by one or more processors of the relay wireless communication device, may cause the relay wireless communication device to receive, from the network node and via the second RAT, configuration information for the cell group, the configuration information being associated with the one or more capabilities associated with the second RAT. The set of instructions, when executed by one or more processors of the relay wireless communication device, may cause the relay wireless communication device to transmit, to the client wireless communication device and via the first RAT, the configuration information for the cell group.

Some aspects described herein relate to a non-transitory computer-readable medium that stores a set of instructions for wireless communication by a network node. The set of instructions, when executed by one or more processors of the network node, may cause the network node to receive, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT. The set of instructions, when executed by one or more processors of the network node, may cause the network node to transmit, to the relay wireless communication device and via the second RAT, configuration information for the cell group, the configuration information being associated with the one or more capabilities associated with the second RAT. The set of instructions, when executed by one or more processors of the network node, may cause the network node to receive, from the client wireless communication device and via the second RAT, a request to establish a connection with the network node for the second RAT in accordance with the configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example wireless communication network in accordance with the present disclosure.

FIG. 4 is a diagram illustrating an example of using hot spot communications in accordance with the present disclosure.

FIG. 5 is a diagram illustrating an example associated with establishing a direct radio link for data offloading of a relay device in accordance with the present disclosure.

FIG. 6 is a diagram illustrating an example associated with establishing a direct radio link between a network node and a client device in accordance with the present disclosure.

FIG. 7 is a diagram illustrating an example associated with maintaining a direct radio link between a network node and a client device in accordance with the present disclosure.

FIG. 8 is a diagram illustrating an example associated with resolution for failed establishment of a direct radio link between a network node and a client device in accordance with the present disclosure.

FIG. 9 is a flowchart illustrating an example process performed, for example, at a user equipment (UE) or an apparatus of a UE that supports data offload from a relay device in accordance with the present disclosure.

FIG. 10 is a flowchart illustrating an example process performed, for example, at a UE or an apparatus of a UE that supports data offload to a client device in accordance with the present disclosure.

FIG. 11 is a flowchart illustrating an example process performed, for example, at a network node or an apparatus of a network node that supports wireless communications in accordance with the present disclosure.

FIG. 12 is a diagram of an example apparatus for wireless communication that supports data offload from a relay device in accordance with the present disclosure.

FIG. 13 is a diagram of an example apparatus for wireless communication that supports data offload from a relay device in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, data connectivity for one or more wireless devices may be facilitated through an intermediary device that is enabled to communicate over multiple radio access technologies (RATs). For example, a relay device, which may be capable of accessing a wireless wide area network (WWAN), may extend network connectivity to one or more client devices that lack direct access to the WWAN (such as a client device without a subscription or other authorization to directly access the WWAN). The relay device may extend such network connectivity through wireless local area network (WLAN) technologies, where the relay device acts as an intermediary, bridging the gap between a WWAN RAT (for example, 4G Long Term Evolution (LTE) or 5G New Radio (NR), among other examples) and a WLAN RAT (for example, an IEEE 802.11 wireless communication protocol, commonly known as “Wi-Fi”). For example, the relay device may communicate directly with a network node via a WWAN link, and may communicate directly with a client device via a WLAN link. Therefore, the relay device may operate in accordance with WWAN and WLAN capabilities to create a multiple RAT (multi-RAT) access bridge, where the client device communicates with the relay device to transmit and/or receive data via the WLAN link and the relay device communicates with the network node via the WWAN link to relay the transmitted and/or received data on behalf of the client device.

In some examples of facilitating data communications between the client device and the network node, the relay device may decode and re-encode information in accordance with the respective RATs associated with the client device and network node. For example, if the relay device receives a data message from the client device, the relay device may decode the data message in accordance with a WLAN decoding protocol and then re-encode the data message in accordance with a WWAN encoding protocol to transmit the data message to the network node. However, such decoding and re-encoding operations may be associated with an increase in latency, compared to a direct communication link between the client device and network node. Additionally, packet latency may increase due to routing communications through the relay device (if compared to a direct link between the network node and the client device). Additionally, relaying wireless communications by the relay device causes power consumption by the relay device, which may decrease power efficiency at the relay device (such as in scenarios where the relay device is a battery-powered device). Additionally or alternatively, the client device may have to remain within an effective transmitting distance (within WLAN coverage) of the relay device. Therefore, remaining within the effective transmitting distance may reduce mobility capabilities of the client device and/or the relay device.

Various aspects relate generally to data offloading from a relay device that facilitates connectivity between a network node and a client device. Some aspects more specifically relate to techniques to establish a direct WWAN link between the network node and the client device, where the direct WWAN link leverages WWAN access authorization associated with the relay device. For example, in some aspects, the relay device may transmit a request to the network node to configure a sharing cell group for communications with the client device in accordance with an identifier module profile of the relay device (such as a subscriber identity module (SIM) or an identity token), where the identifier module profile extends WWAN authorization to the client device. In other words, the client device (which may have WWAN capabilities but lack WWAN authorization) may establish a WWAN link directly with the network node by using the identifier module profile of the relay device as a proxy for WWAN authorization. In some aspects, the client device, the relay device, and/or the network node may configure one or more parameters associated with the sharing cell group. For example, the one or more parameters may include an active time duration associated with communications via the sharing cell group, a volume of data threshold for the sharing cell group, a data rate of the sharing cell group, or a cool down timer that may be used if the client device fails to establish a connection to the sharing cell group.

Particular aspects of the subject matter described in this disclosure can be implemented to realize one or more of the following potential advantages. In some examples, the described techniques can be used to reduce communication traffic at the relay device. For example, the sharing cell group may be used to communicate data information and/or control information between the network node and the client device,

decreasing a quantity of traffic handled by the relay device. Such reductions in traffic at the relay device may reduce power consumption and processing overhead at the relay device. Additionally or alternatively, the client device and/or the relay device may experience an increase in mobility. For example, by establishing a direct WWAN link with the network node, the client device is less reliant on proximity to the relay device to maintain network connectivity. Therefore, after establishing initial access to the sharing cell group via the relay device, a distance between the relay device and the client device may increase without degrading quality of service (QoS) for wireless communications by the client device. Additionally, the described techniques can be used to reduce uplink and/or downlink latency because packets may travel one fewer hop between the client device and the network node.

As described above, wireless communication systems may be deployed to provide various services, which may involve carrying or supporting voice, text, other messaging, video, data, and/or other traffic. Some wireless communications systems may employ multiple-access RATs. The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

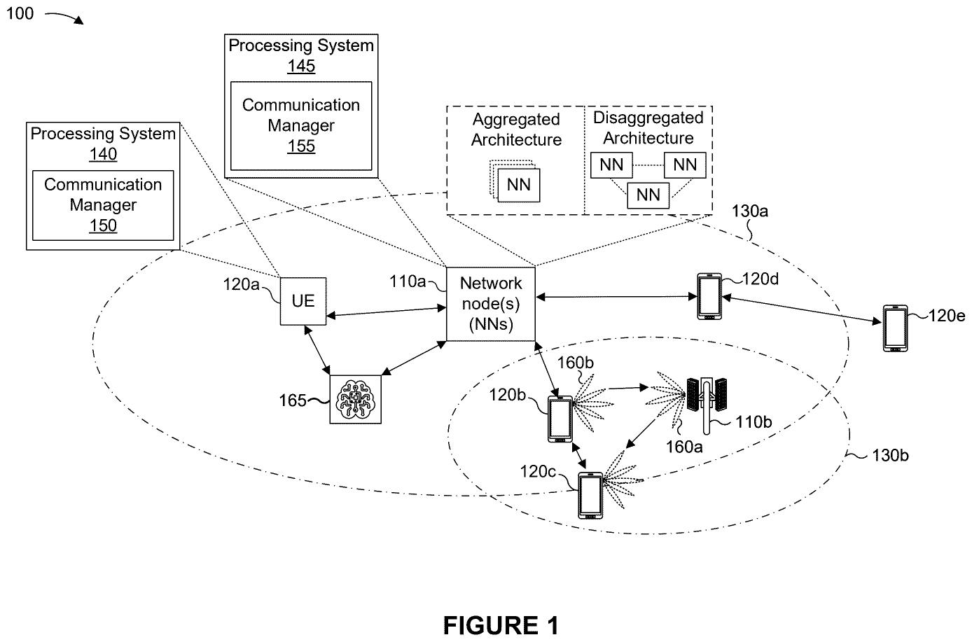

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR 2 (24.25 GHz through 52.6 GHz), FR 3 (7.125 GHz through 24.25 GHz), FR4a or FR 4-1 (52.6 GHz through 71 GHz), FR 4 (52.6 GHz through 114.25 GHz), and FR 5 (114.25 GHz through 300 GHz). Although a portion of FR 1 is greater than 6 GHz, FR 1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR 1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

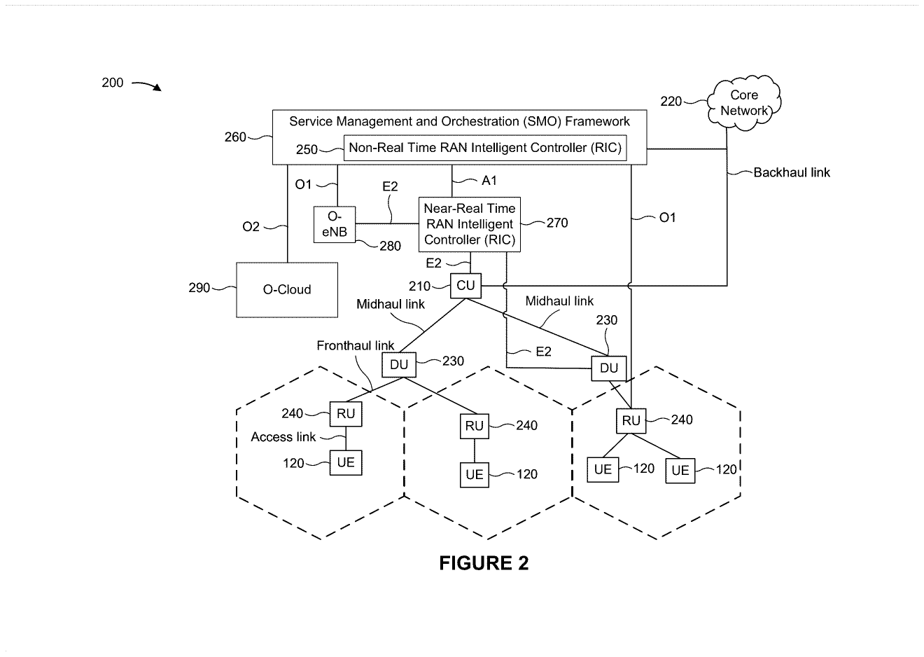

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary synchronization signal (SSS), a synchronization signal block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some examples, any UE 120 that relays communications may be referred to as a relay device, a relay station, or simply as a relay. A relay may receive a transmission of a communication from an upstream station (for example, a network node 110 or another UE 120) and transmit the communication to a downstream station (for example, a UE 120 or network node 110). In this case, the wireless communication network 100 may include or be referred to as a “multi-hop network.” In the example shown in FIG. 1, the UE 120d (for example, a relay device) may communicate with the network node 110a and the UE 120e (for example, a client device) in order to facilitate communication between the network node 110a and the UE 120e (for example, when the UE 120e is outside a coverage area of the cell 130a provided by the network node 110a). Additionally or alternatively, a network node 110 may be or may operate as a relay that can relay transmissions to or from other UEs 120 or other wireless communication devices. A network node 110 that relays communications may be referred to as a network node relay or a relay network node, among other examples.

In some examples, a relay UE 120 may include an electromagnetic radiation reflective component that can be used to relay (for example, reflect) signals from a first network node 110 to a second network node 110 or another UE 120. Such a relay UE 120 can include, for example, a radio frequency reflection array configured to perform radio frequency reflection functions. The electromagnetic radiation reflective array can be, for example, a reconfigurable intelligent surface (RIS) (which also can be referred to as an intelligent reflective surface (IRS)).

In some aspects, the UE 120 may include a communication manager 150. As described in more detail elsewhere herein, the communication manager 150 may transmit, to a relay wireless communication device and via a first RAT, information indicating one or more capabilities associated with a second RAT; receive, from the relay wireless communication device and via the first RAT, configuration information for a cell group associated with a network node, the configuration information being associated with the one or more capabilities associated with the second RAT; and transmit, to the network node and via the second RAT, a request to establish a connection with the network node for the second RAT in accordance with the configuration information.

Additionally or alternatively, the communication manager 150 may receive, from a client wireless communication device and via a first RAT, information indicating one or more capabilities associated with a second RAT; transmit, to a network node and via the second RAT, a cell group request indicating a request for the network node to establish a cell group for connection between the client wireless communication device and the network node for the second RAT, the cell group request including the one or more capabilities associated with the second RAT; receive, from the network node and via the second RAT, configuration information for the cell group, the configuration information being associated with the one or more capabilities associated with the second RAT; and transmit, to the client wireless communication device and via the first RAT, the configuration information for the cell group. Additionally or alternatively, the communication manager 150 may perform one or more other operations described herein.

In some aspects, the network node 110 may include a communication manager 155. As described in more detail elsewhere herein, the communication manager 155 may receive, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT; transmit, to the relay wireless communication device and via the second RAT, configuration information for the cell group, the configuration information being associated with the one or more capabilities associated with the second RAT; and receive, from the client wireless communication device and via the second RAT, a request to establish a connection with the network node for the second RAT in accordance with the configuration information; Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

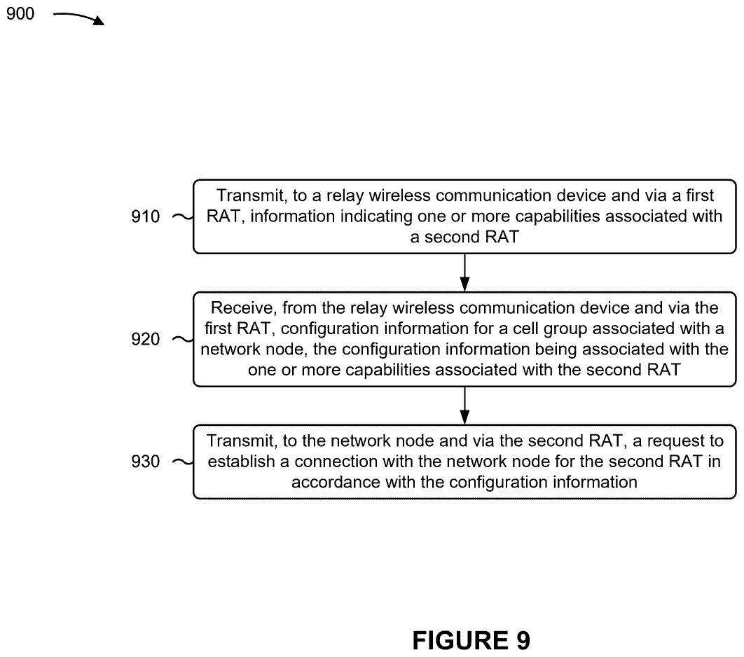

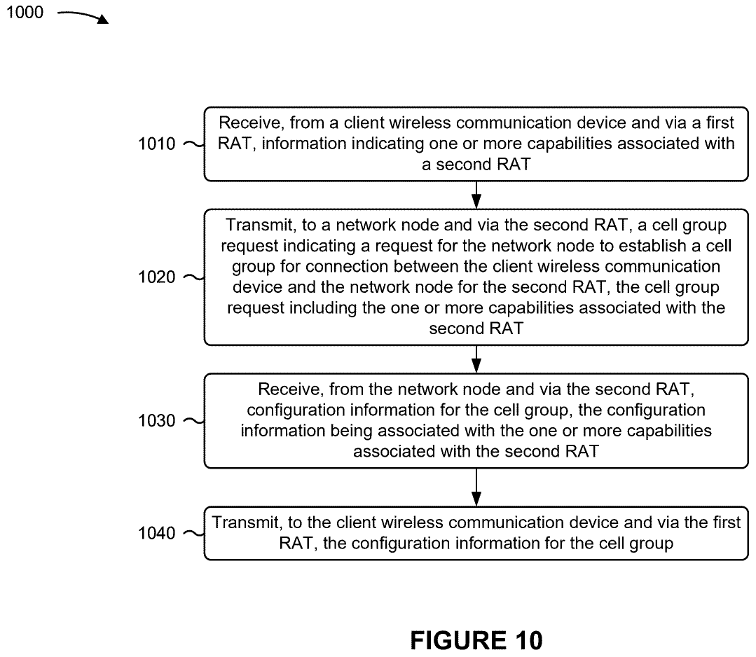

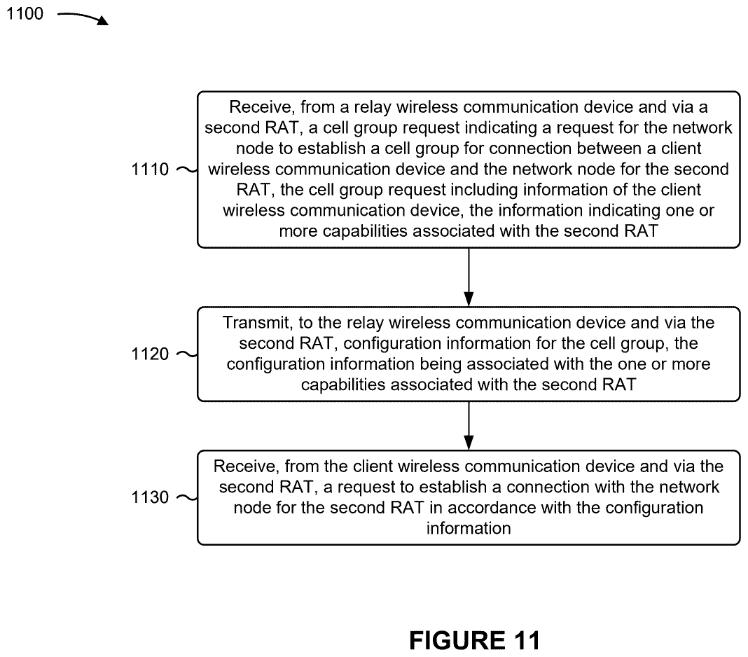

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with data offload from a relay device, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, process 1100 of FIG. 11, or other processes as described herein (alone or in conjunction with one or more other processors). In some aspects, the client wireless communication device and/or the relay wireless communication device described herein may be the UE 120, may be included in the UE 120, or may include one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for transmitting, to a relay wireless communication device and via a first RAT, information indicating one or more capabilities associated with a second RAT; means for receiving, from the relay wireless communication device and via the first RAT, configuration information for a cell group associated with a network node, the configuration information being associated with the one or more capabilities associated with the second RAT; and/or means for transmitting, to the network node and via the second RAT, a request to establish a connection with the network node for the second RAT in accordance with the configuration information.

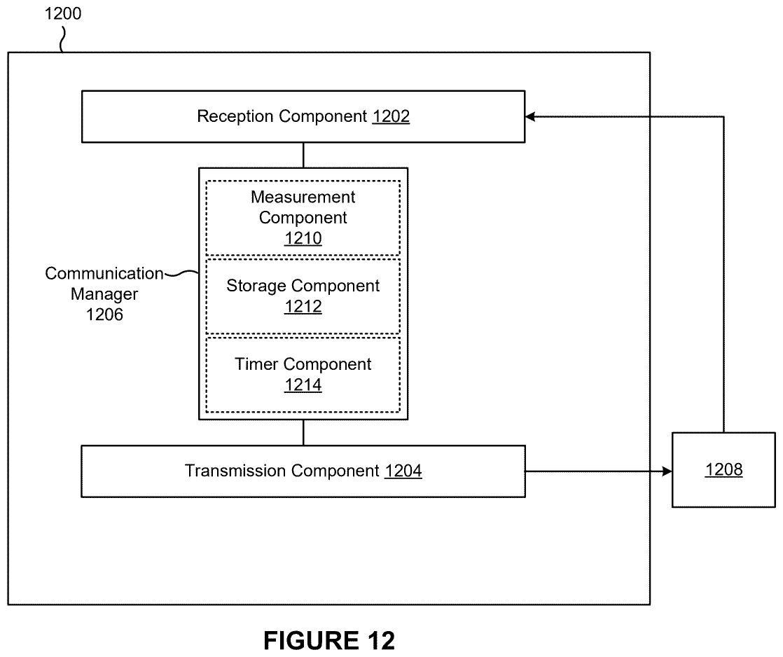

Additionally or alternatively, the UE 120 includes means for receiving, from a client wireless communication device and via a first RAT, information indicating one or more capabilities associated with a second RAT; means for transmitting, to a network node and via the second RAT, a cell group request indicating a request for the network node to establish a cell group for connection between the client wireless communication device and the network node for the second RAT, the cell group request including the one or more capabilities associated with the second RAT; means for receiving, from the network node and via the second RAT, configuration information for the cell group, the configuration information being associated with the one or more capabilities associated with the second RAT; and/or means for transmitting, to the client wireless communication device and via the first RAT, the configuration information for the cell group. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

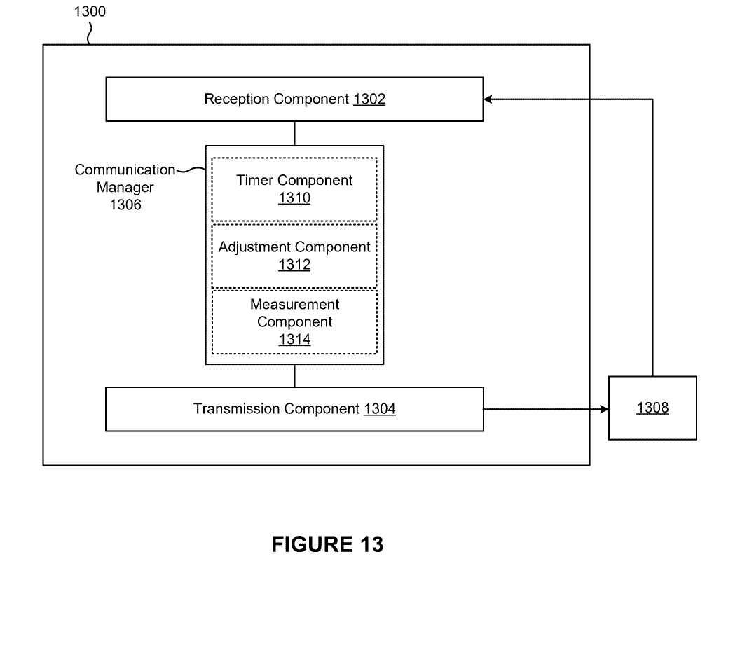

In some aspects, the network node 110 includes means for receiving, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT; means for transmitting, to the relay wireless communication device and via the second RAT, configuration information for the cell group, the configuration information being associated with the one or more capabilities associated with the second RAT; and/or means for receiving, from the client wireless communication device and via the second RAT, a request to establish a connection with the network node for the second RAT in accordance with the configuration information. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

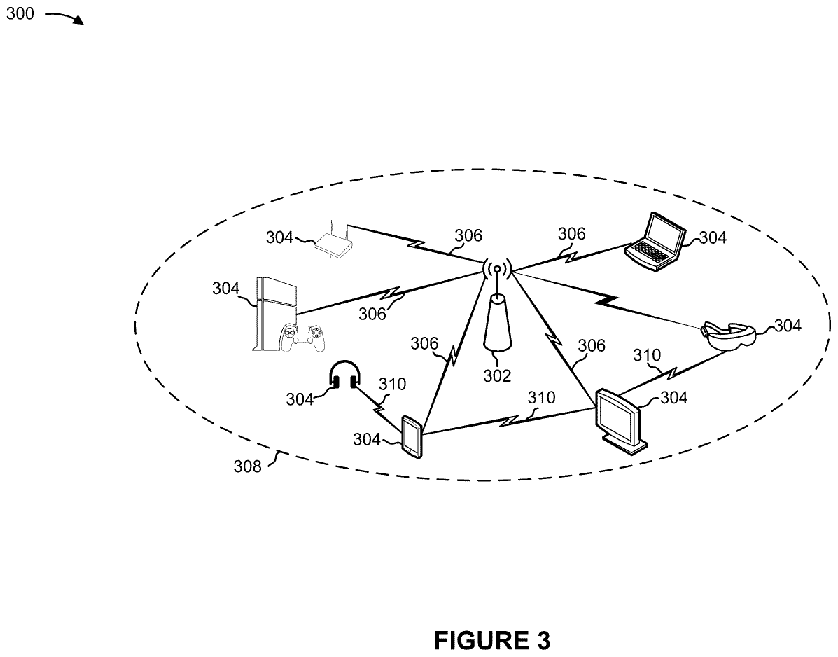

FIG. 3 is a diagram illustrating an example wireless communication network 300 in accordance with the present disclosure. In some aspects, the wireless communication network 300 can be an example of a WLAN, such as a Wi-Fi network. For example, the wireless communication network 300 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 300 can be an example of a cellular RAN, such as a 5G or 6G RAN that implements one or more cellular protocols such as those specified in one or more 3GPP standards. In some other examples, the wireless communication network 300 can include a WLAN that functions in an interoperable or converged manner with one or more cellular RANs to provide greater or enhanced network coverage to wireless communication devices within the wireless communication network 300 or to enable such devices to connect to a cellular network core, such as to access the network management capabilities and functionality offered by the cellular network core. In some other examples, the wireless communication network 300 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 300 may include numerous wireless communication devices including at least one wireless AP 302 and any number of wireless stations (STAs) 304. While only one AP 302 is shown in FIG. 3, the wireless communication network 300 can include multiple APs 302. The AP 302 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a TRP or another type of device or equipment included in a RAN, including O-RAN network entities, such as a CU, a DU or an RU.

Each of the STAs 304 also may be referred to as a mobile station (MS), a mobile device, a mobile handset, a wireless handset, an access terminal (AT), a UE, a subscriber station (SS), or a subscriber unit, among other examples. The STAs 304 may represent various devices such as mobile phones, other handheld or wearable communication devices, netbooks, notebook computers, tablet computers, laptops, Chromebooks, augmented reality (AR), virtual reality (VR), mixed reality (MR) or XR wireless headsets or other peripheral devices, wireless earbuds, other wearable devices, display devices (for example, televisions, computer monitors, or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), IoT devices, and vehicles, among other examples.

A single AP 302 and an associated set of STAs 304 may be referred to as a basic service set (BSS), which is managed by the respective AP 302. FIG. 3 additionally shows an example coverage area 308 of the AP 302, which may represent a basic service area (BSA) of the wireless communication network 300. The BSS may be identified by STAs 304 and other devices by a service set identifier (SSID), as well as a basic service set identifier (BSSID), which may be a MAC address of the AP 302. The AP 302 may periodically broadcast beacon frames (“beacons”) including the BSSID to enable any STAs 304 within wireless range of the AP 302 to “associate” or re-associate with the AP 302 to establish a respective communication link 306 (hereinafter also referred to as a “Wi-Fi link” or “WLAN link”), or to maintain a communication link 306, with the AP 302. For example, the beacons can include an identification or indication of a primary channel used by the respective AP 302 as well as a timing synchronization function (TSF) for establishing or maintaining timing synchronization with the AP 302. The AP 302 may provide access to external networks to various STAs 304 in the wireless communication network 300 via respective communication links 306.

To establish a communication link 306 with an AP 302, each of the STAs 304 may be configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 304 listens for beacons, which are transmitted by respective APs 302 at periodic time intervals referred to as target beacon transmission times (TBTTs). To perform active scanning, a STA 304 generates and sequentially transmits probe requests on each channel to be scanned and listens for probe responses from APs 302. Each STA 304 may identify, determine, ascertain, or select an AP 302 with which to associate in accordance with the scanning information obtained through the passive or active scans, and to perform authentication and association operations to establish a communication link 306 with the selected AP 302. The selected AP 302 assigns an association identifier (AID) to the STA 304 at the culmination of the association operations, which the AP 302 uses to track the STA 304.

As a result of the increasing ubiquity of wireless networks, a STA 304 may have the opportunity to select one of many BSSs within range of the STA 304 or to select among multiple APs 302 that together form an extended service set (ESS) including multiple connected BSSs. For example, the wireless communication network 300 may be connected to a wired or wireless distribution system that may enable multiple APs 302 to be connected in such an ESS. Therefore, a STA 304 can be covered by more than one AP 302 and can associate with different APs 302 at different times for different transmissions. Additionally, after association with an AP 302, a STA 304 also may periodically scan its surroundings to find a more suitable AP 302 with which to associate. For example, a STA 304 that is moving relative to its associated AP 302 may perform a “roaming” scan to find another AP 302 having more desirable network characteristics such as a greater RSSI or a reduced traffic load.

In some examples, STAs 304 may form networks without APs 302 or other equipment other than the STAs 304 themselves. One example of such a network is an ad hoc network (or wireless ad hoc network). Ad hoc networks may alternatively be referred to as mesh networks, peer-to-peer (P2P), or device-to-device (D2D) networks. In some examples, ad hoc networks may be implemented within a larger network such as the wireless communication network 300. In such examples, while the STAs 304 may be capable of communicating with each other through the AP 302 using communication links 306, STAs 304 also can communicate directly with each other via direct wireless communication links 310. Additionally, two STAs 304 may communicate via a direct wireless communication link 310 regardless of whether both STAs 304 are associated with and served by the same AP 302. In such an ad hoc system, one or more of the STAs 304 may assume the role filled by the AP 302 in a BSS. Such a STA 304 may be referred to as a group owner (GO) and may coordinate transmissions within the ad hoc network. Examples of direct wireless communication links 310 include Wi-Fi Direct connections, connections established by using a Wi-Fi Tunneled Direct Link Setup (TDLS) link, and other P2P group connections.

In some networks, the AP 302 or the STAs 304, or both, may support applications associated with high throughput or low-latency requirements, or may provide lossless audio to one or more other devices. For example, the AP 302 or the STAs 304 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 302 or the STAs 304 may support an extended personal audio network enabling communication with the two or more peripheral devices. Additionally, the AP 302 and STAs 304 may support additional ULL applications such as cloud-based applications (such as VR cloud gaming) that have ULL and high throughput requirements.

As indicated above, in some implementations, the AP 302 and the STAs 304 may function and communicate (via the respective communication links 306) according to one or more of the IEEE 802.11 family of wireless communication protocol standards. These standards define the WLAN radio and baseband protocols for the PHY and MAC layers. The AP 302 and STAs 304 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 302 and STAs 304 in the wireless communication network 300 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 302 and STAs 304 described herein also may communicate in other frequency bands that may support licensed or unlicensed communications. For example, the APs 302 or STAs 304, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. Therefore, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 302 may determine or select an operating or operational bandwidth for the STAs 304 in its BSS and select a range of channels within a band to provide that operating bandwidth. For example, the AP 302 may select sixteen 20 MHz channels that collectively span an operating bandwidth of 320 MHz. Within the operating bandwidth, the AP 302 may typically select a single primary 20 MHz channel on which the AP 302 and the STAs 304 in its BSS monitor for contention-based access schemes. In some examples, the AP 302 or the STAs 304 may be capable of monitoring only a single primary 20 MHz channel for packet detection (for example, for detecting preambles of PPDUs). Conventionally, any transmission by an AP 302 or a STA 304 within a BSS must involve transmission on the primary 20 MHz channel. Therefore, in conventional systems, the transmitting device must contend on and win a TXOP on the primary channel to transmit anything at all. However, some APs 302 and STAs 304 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

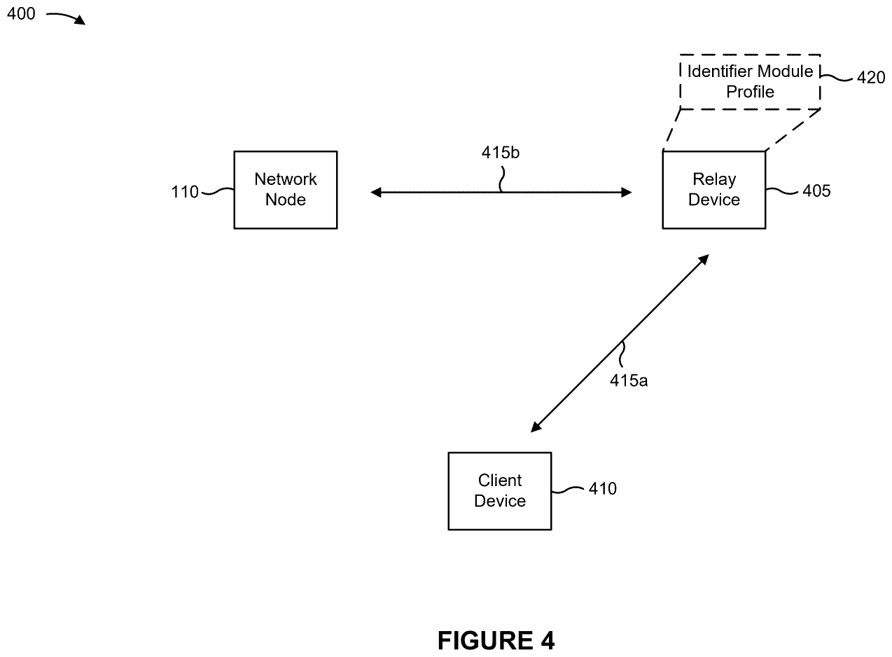

FIG. 4 is a diagram illustrating an example 400 of using hot spot communications in accordance with the present disclosure. In some aspects, example 400 may implement or be implemented by one or more aspects of wireless communication network 100, network node architecture 200, or wireless communication network 300. For example, network node 110 may be an example of a network node 110 as described with reference to FIGS. 1 and 2. Additionally, the relay device 405 may be an example of a relay UE 120, a relay network node 110, an AP 302, or an STA 304 as described with reference to FIGS. 1 through 3. Additionally, the client device 410 may be an example of a UE 120, an AP 302, or an STA 304 as described with reference to FIGS. 1 through 3.

As illustrated in FIG. 4, the network node 110, the client device 410, and the relay device 405 may communicate with one another via one or more radio links 415. For example, the client device 410 and the relay device 405 may communicate via a radio link 415a and the relay device 405 and the network node 110 may communicate via a radio link 415b. In some examples, the radio link 415a and the radio link 415b may be associated with different RATs. For instance, the radio link 415a may be a WLAN link associated with a WLAN RAT (such as Wi-Fi), a wireless personal area network (WPAN) link associated with a WPAN RAT (such as Bluetooth) and/or a D2D link associated with a D2D RAT (such as near field communication (NFC) or powerline). Additionally, the radio link 415b may be a WWAN link associated with a WWAN RAT (such as 4G, 5G, and/or 6G).

In some examples, the relay device 405 may be capable of wireless communications in accordance with multiple types of RATs. For example, the relay device 405 may have capabilities to communicate in accordance with the WWAN RAT, the WLAN RAT, and/or the WPAN RAT. Additionally, the relay device 405 may be authorized to communicate via a WWAN link (such as radio link 415b). For example, authorization to use a WWAN link for wireless communications may involve verifying and granting access for the relay device 405 to connect to a cellular network associated with the network node 110. Such a verification and grant to connect to the cellular network may be associated with an identifier module profile 420 of the relay device 405 (such as a SIM, an embedded SIM (eSIM), an integrated SIM (iSIM), a removable user identity module (R-UIM), a universal SIM (USIM), or another token identifier). For example, the identifier module profile 420 may include or may be associated with a profile that includes and/or indicates identifiers (such as an internation mobile subscriber identity (IMSI) and authentication keys) for recognizing and validating a subscriber identity with the cellular network. That is, the identifier module profile 420 associated with the relay device 405 may indicate to the network node 110 that the relay device 405 is subscribed and/or authorized to wirelessly communicate with the cellular network via a WWAN link.

In some examples, the client device 410 may be capable of wireless communications in accordance with multiple types of RATs. For example, the client device 410 may have capabilities to communicate in accordance with the WWAN RAT, the WLAN RAT, and/or the WPAN RAT. In some cases, however, the client device 410 may not be authorized to communicate with the network node 110 via a WWAN link. For example, the client device 410 may not be associated with an identifier module profile 420 that authorizes wireless communications with the cellular network via a WWAN link. Therefore, despite having hardware that supports communication via the WWAN RAT, the client device 410 may not be authorized to communicate directly with the network node 110 in accordance with a WWAN link.

Therefore, the client device 410 may communicate with the network node 110 by using the relay device 405 as an intermediary communication device. For example, the client device 410 may communicate one or more data packets (including data or control information) with the relay device 405 via radio link 415a in accordance with the WLAN RAT and/or the WPAN RAT, and the network node 110 may communicate one or more data packets with the relay device 405 via the radio link 415b in accordance with the WWAN RAT.

In some examples, the relay device 405 may route data packets from the client device 410 to the network node 110 via an uplink. For instance, the client device 410 may transmit a data packet to the relay device 405 via the radio link 415a, where the client device 410 may encode the data packet in accordance with a WLAN protocol stack (structured according to the IEEE 802.11 standards). Therefore, the relay device 405 may decode the data packet in accordance with the WLAN protocol stack and re-encode the data packet in accordance with a WWAN protocol stack (structured according to the 3GPP standards). In accordance with re-encoding the data packet using the WWAN protocol stack, the relay device 405 may transmit the data packet to the network node 110 via the radio link 415b. Therefore, the network node 110 may decode the data packet in accordance with the WWAN protocol stack.

In some examples, the relay device 405 may route data packets from the network node 110 to the client device 410 via a downlink. For instance, the network node 110 may transmit a data packet to the relay device 405 via the radio link 415b, where the network node 110 may encode the data packet in accordance with the WWAN protocol stack. Therefore, the relay device 405 may decode the data packet in accordance with the WWAN protocol stack and re-encode the data packet in accordance with the WLAN protocol stack. In accordance with re-encoding the data packet using the WLAN protocol stack, the relay device 405 may transmit the data packet to the client device 410 via the radio link 415a. Therefore, the client device 410 may decode the data packet in accordance with the WLAN protocol stack.

By decoding and re-encoding data packets in accordance with respective RAT protocol stacks, the relay device 405 may facilitate wireless communications between the network node 110 and the client device 410 without the client device 410 being authorized to communicate directly with the network node 110 via a WWAN link. In some cases, however, such decoding and re-encoding operations may be associated with an increase in latency, compared to a direct communication link between the client device 410 and the network node 110. Additionally, packet latency may increase due to routing communications through the relay device (as compared to a direct link between the network node and the client device). Additionally, as wireless communications serviced by the relay device 405 increase, power consumption by the relay device 405 may increase, which may decrease power efficiency at the relay device 405. Therefore, in examples where the relay device 405 is a battery powered device, the decrease in power efficiency may reduce a duration in which the relay device 405 may service the client device 410. Additionally or alternatively, the client device 410 may have to remain within an effective transmitting distance of the relay device 405. For example, the radio link 415a may be associated with a geographic coverage area, where if the client device 410 moves outside of the geographic coverage area, a service quality associated with the radio link 415a may drop below a threshold or the client device 410 may lose connection with the relay device 405 via the radio link 415a. Therefore, remaining within the effective transmitting distance may reduce mobility capabilities of the client device 410 and/or the relay device 405.

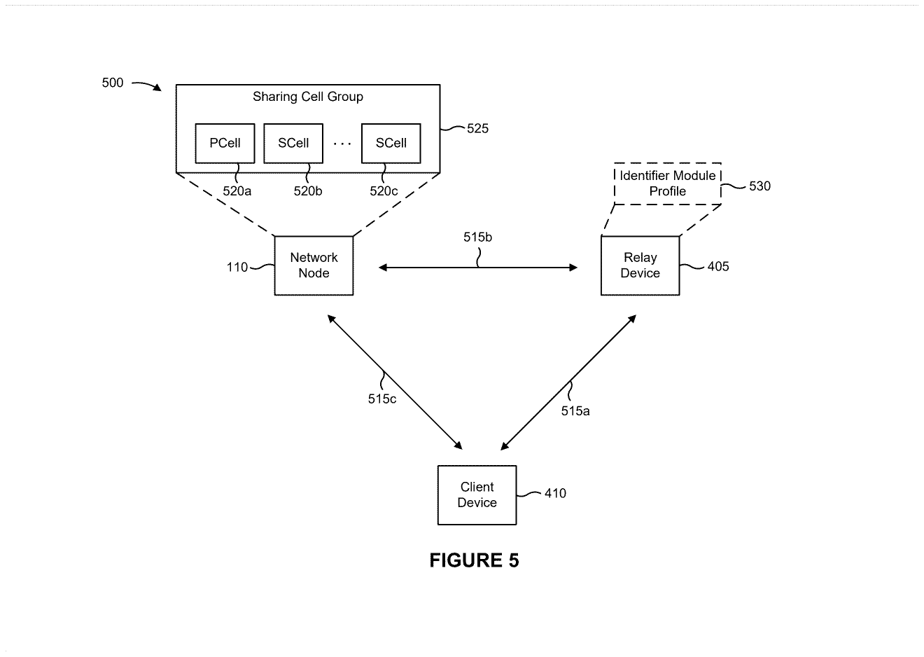

Various aspects relate generally to data offloading from the relay device 405 that facilitates connectivity between a network node 110 and a client device 410. Some aspects more specifically relate to techniques to establish a direct WWAN link between the network node 110 and the client device 410, where the direct WWAN link leverages WWAN access authorization associated with the relay device 405. Some aspects more specifically relate to the relay device 405 transmitting a request to the network node 110 to configure a sharing cell group for communications with the client device 410 in accordance with the identifier module profile 420 of the relay device 405, where the identifier module profile extends WWAN authorization to the client device 410. In other words, the client device 410 (which may have WWAN capabilities but lack WWAN authorization) may establish a WWAN link directly with the network node 110 by using the identifier module profile 420 as a proxy for WWAN authorization. Further description of the client device 410 establishing connection with the network node 110 via a WWAN link is provided herein, including with reference to FIG. 5.

FIG. 5 is a diagram illustrating an example 500 associated with establishing a direct radio link for data offloading of a relay device in accordance with the present disclosure. In some aspects, example 500 may implement or be implemented by one or more aspects of wireless communication network 100, network node architecture 200, wireless communication network 300, or example 400. For example, a radio link 515a may be an example of the radio link 415a (such as a WLAN or WPAN radio link), a radio link 515b may be an example of the radio link 415b (such as a WWAN link), and an identifier module profile 530 may be an example of the identifier module profile 420.

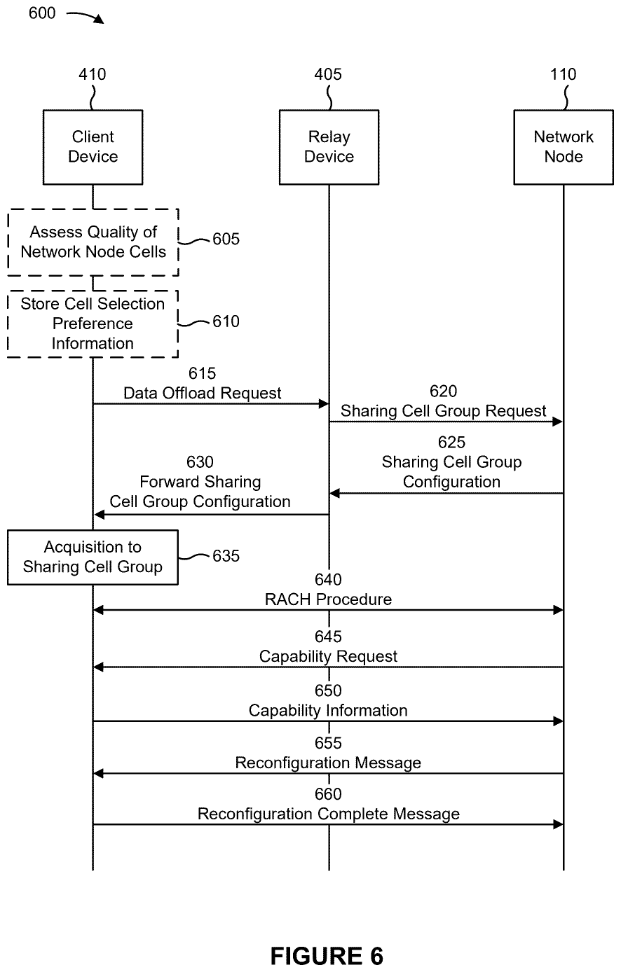

In accordance with some aspects described herein, the client device 410 may establish a connection with the network node 110 via the radio link 515c. For instance, the radio link 515 c may be a WWAN link associated with a WWAN RAT (such as 4G, 5G, and/or 6G). In some examples, the client device 410 and the network node 110 may establish the radio link 515c by leveraging a WWAN authorization associated with the relay device 405. For example, the relay device 405 may transmit, to the network node 110 via the radio link 515b, a request for the network node 110 to establish a sharing cell group 525 for communications between the network node 110 and the client device 410. In some examples, the network node 110 may configure the sharing cell group 525 in accordance with the identifier module profile 530 of the relay device 405. In other words, the network node 110 may apply information associated with the identifier module profile 530 to the sharing cell group 525. Further description of how the network node 110 configures the sharing cell group 525 in accordance with the identifier module profile 530 is provided elsewhere herein, including with reference to FIG. 6.

As illustrated in example 500, the sharing cell group 525 may include a set of cells 520 (such as cell 520a, 520b, and 520c). For example, the sharing cell group 525 may include a primary cell (PCell) such as the cell 520a and one or more secondary cells (SCells) such as the cell 520b and the cell 520c. In some examples, the PCell may serve as an anchor for control signaling between the client device 410 and the network node 110. For example, the PCell may be the primary point of communication between the client device 410 and the network node 110 by handling the control plane signaling (which includes signaling related to initial access, connection setup, mobility management, and/or handover procedures, among other examples). The PCell may also manage radio link controls, such as RRC messages, ensuring that the client device 410 remains connected to the network. In scenarios with carrier aggregation (CA) or dual connectivity (DC), the PCell may serve as the base carrier that establishes and maintains the connection (such as the radio link 515c) between the client device 410 and the network node 110. Additionally, the SCells may provide additional resources to enhance data throughput for the radio link 515c. For example, the network node 110 may use one or more SCells to boost user plane data capacity, allowing the client device 410 to achieve higher data rates by utilizing multiple carriers concurrently. In some examples, the network node 110 may dynamically activate or deactivate one or more SCells in accordance with radio conditions, data traffic, and/or network capacity, ensuring that resources are allocated efficiently. Such a structure of a PCell and one or more SCells may enable the network node 110 to distribute a data load and efficiently utilize available frequency bands. Therefore, the one or more cells 520 of the sharing cell group 525 may work together to provide radio resources for the client device 410 to communicate with the network node 110. Additionally, although the sharing cell group 525 is illustrated in FIG. 5 as including one PCell and two SCells, the sharing cell group 525 may include any suitable quantity of cells 520.

As described herein, the client device 410 may access the sharing cell group 525 to establish the radio link 515c with the network node 110. In other words, the sharing cell group 525 may be associated with a WWAN RAT (such as 4G, 5G, and/or 6G). In some examples, the client device 410 and network node 110 may communicate data packets (including user data) over the sharing cell group 525 via the radio link 515c. Additionally or alternatively, the sharing cell group 525 may be associated with a data radio bearer (DRB). For example, a DRB may be a logical channel that is established between the client device 410 and the network node 110 to carry user plane data. For instance, the user plane data transmitted over a DRB may include any user-generated traffic, such as internet browsing traffic, video streaming traffic, voice over IP (VoIP) traffic, or traffic associated with other data services that the user may access through the network. In some examples, the network node 110 may establish multiple DRBs associated with the sharing cell group 525 to accommodate various types of user data. Additionally or alternatively, the one or more DRBs may be specific to the sharing cell group 525. For example, the one or more DRBs may be associated with the identifier module profile 530 of the relay device 405 to enable WWAN authorization at the client device 410.

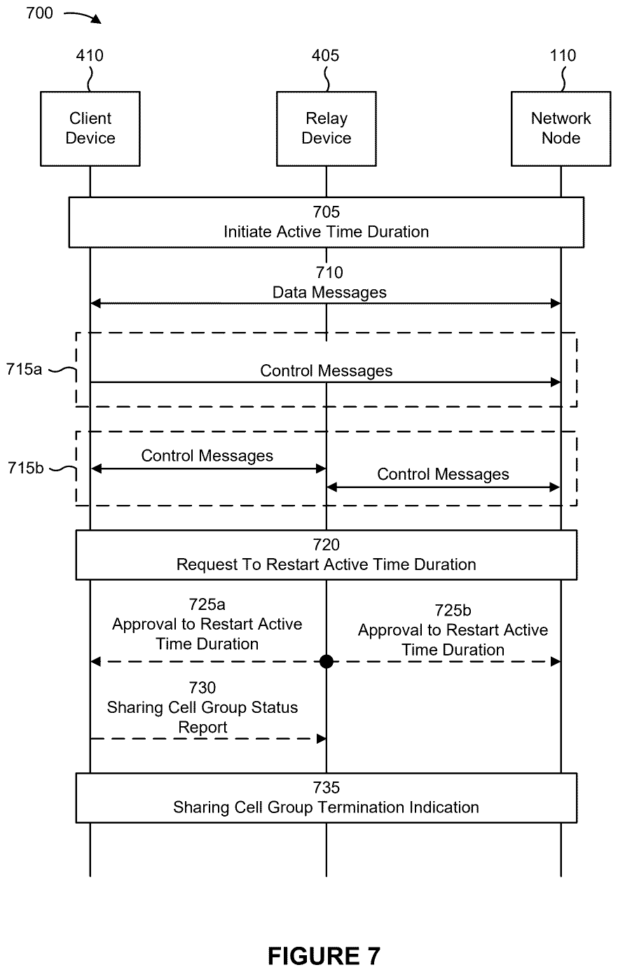

Additionally or alternatively, the network node 110 may enable the sharing cell group 525 with control plane (C-plane) signaling. For example, C-plane signaling may be used for establishing, maintaining, and terminating the communication sessions and connections, as well as managing resources, mobility, and other network functions. In some examples, the protocols associated with the C-plane signaling include RRC for radio access signaling and non-access stratum (NAS) for core network control functions. In some examples, whether the sharing cell group 525 facilitates C-plane signaling between the network node 110 and client device 410 may be in accordance with one or more capabilities of the client device 410 (such as signaling radio bearer (SRB) support at the client device 410). If the sharing cell group 525 is not configured to facilitate C-plane signaling, then the relay device 405 may relay C-plane signaling between the network node 110 and the client device 410. Further description of whether control signaling is facilitated via the sharing cell group 525 or via the relay device 405 is provided elsewhere herein, including with reference to FIGS. 6 and 7.

In accordance with establishing initial access to the sharing cell group 525, the client device 410 and the network node 110 may directly communicate client data (such as user data and/or control data) rather than routing client data through the relay device 405. Additionally, the client device 410, relay device 405, and network node 110 may maintain the sharing cell group 525 and the radio link 515c in accordance with one or more cell group maintenance communications. Further description of the one or more cell group maintenance communications is provided elsewhere herein, including with reference to FIG. 7.

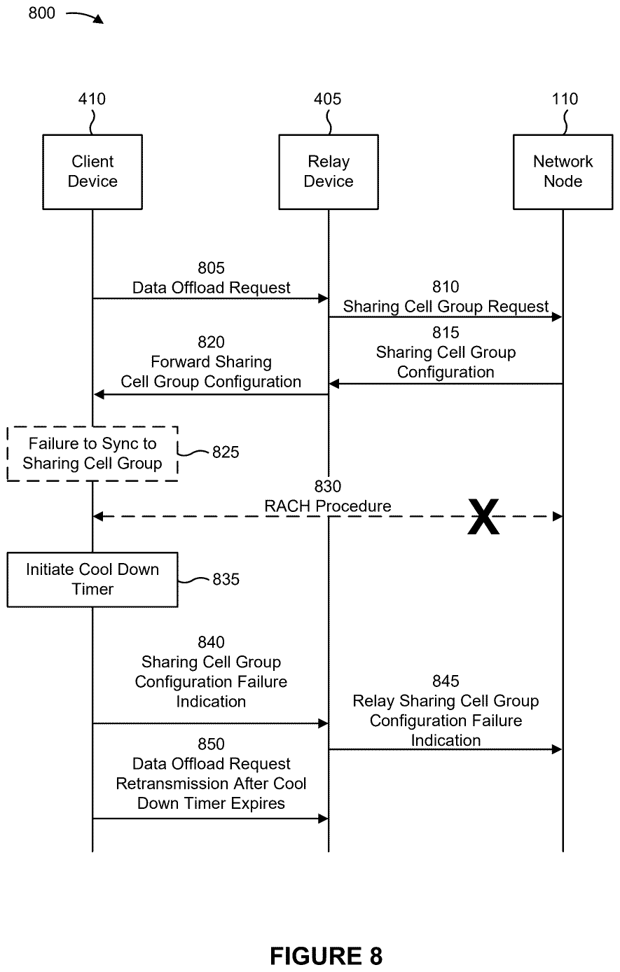

In some examples, the client device 410 may be unable to establish initial access to the sharing cell group 525 (for example, in accordance with a failure to synchronize to the sharing cell group 525, a failure of a RACH procedure, or another failure). In such examples, the client device 410 may initiate a cool down timer and may reattempt to establish initial access to the sharing cell group 525 after expiration of the cool down timer. Further description of the cool down timer is provided elsewhere herein, including with reference to FIG. 8.

Particular aspects of the subject matter described in this disclosure can be implemented to realize one or more of the following potential advantages. In some examples, the described techniques can be used to reduce communication traffic at the relay device 405. For example, the sharing cell group 525 may be used to communicate data information and/or control information between the network node 110 and client device 410, decreasing a quantity of traffic handled by the relay device 405. Such reductions in traffic at the relay device 405 may reduce power consumption and processing overhead at the relay device 405. Additionally or alternatively, the client device 410 and/or the relay device 405 may experience an increase in mobility. For example, by establishing the radio link 515c with the network node 110, the client device 410 is less reliant on a proximity to the relay device 405 to maintain network connection. Therefore, after establishing initial access to the sharing cell group 525, a distance between the relay device 405 and the client device 410 may increase without degrading QoS for wireless communications by the client device 410. Additionally, the described techniques can be used to reduce uplink and/or downlink latency because packets may travel one fewer hop between the client device 410 and the network node 110.

Additionally, using the sharing cell group 525 for the direct WWAN communications may realize one or more advantages compared to carrier aggregation associated with routing communication through the relay device 405. For example, by offloading client data to the radio link 515c, the relay device 405 may refrain from aggregating downlink data at the MAC layer, which may reduce power consumption at the relay device 405. Additionally, the relay device 405 may refrain from synchronizing timing schemes between multiple component carriers, which may reduce complexity to maintain timing across multiple component carriers. Additionally, the sharing cell group 525 may be associated with supporting a discontinuous reception (DRX) mode of the client device 410, reducing the complexity of the relay device 405 handling respective DRX modes for multiple devices. Additionally, downlink feedback messages (such as ACK and NACK) may be carried by a dedicated component carrier at the relay device 405. Therefore, the sharing cell group 525 may reduce occurrences of the relay device 405 multiplexing downlink feedback messages via the dedicated component carrier, which may reduce complexity at the relay device 405. Additionally, CSI feedback may be handled by a dedicated component carrier at the relay device 405. Therefore, the sharing cell group 525 may reduce CSI feedback routed through the relay device 405, reducing signaling overhead for communicating CSI with the client device 410. Additionally, the sharing cell group 525 may be associated with a component carrier at the client device 410 for uplink transmissions. Therefore, configuring the uplink component carrier may enable improved power control mechanisms between the client device 410 and the network node 110. Additionally, the sharing cell group 525 may be associated with a respective DRB and a single RLC layer, which may enable the client data path via radio link 515c to be independent of the relay device 405, which may reduce signaling overhead at the relay device 405.

FIG. 6 is a diagram illustrating an example 600 associated with establishing a direct radio link between the network node 110 and client device 410 in accordance with the present disclosure. In some examples, the example 600 may implement or be implemented by one or more aspects of wireless communication network 100, network node architecture 200, wireless communication network 300, example 400, or example 500. For example, the example 600 includes wireless communications between the network node 110, the relay device 405, and the client device 410 to establish a WWAN link between the network node 110 and the client device 410. Additionally, the client device 410 and relay device 405 may communicate via a WLAN link or WPAN link (such as the radio link 415a or the radio link 515a), the relay device 405 and the network node 110 may communicate via a WWAN link (such as the radio link 415b or the radio link 515b), and the network node 110 and the client device 410 may communicate via a WWAN link (such as the radio link 515c).

Alternative examples of the following may be implemented, where some operations are performed in a different order than described, or not at all. In some cases, one or more operations may include additional features not mentioned below, or further operations may be added. In addition, while example 600 shows communication between the network node 110, the client device 410, and the relay device 405, the communication may occur between any quantity of network devices of various types described herein.

In a first operation 605, the client device 410 may optionally assess signal quality of one or more network node 110 cells. For example, the client device 410 may perform signal quality measurements of one or more cells associated with the network node 110 (such as cells 520, as described in FIG. 5). For example, the client device 410 may measure the signal quality of the one or more cells to assess the conditions of respective potential radio links associated with each of the one or more cells. In some examples, the signal quality measurements for each cell may include one or more of an RSRP measurement, an RSRQ measurement, a signal-to-interference-plus-noise ratio (SINR) measurement, or an RSSI measurement. Additionally or alternatively, the client device may assess one or more parameters associated with signal quality of the cells including one or more of a CQI value, a block error rate (BLER) value, or a timing advance (TA) value.

In a second operation 610, the client device 410 may optionally store cell selection preference information in a storage component of the client device 410. For example, the cell selection preference information may order the cells in accordance with the signal quality measurements obtained during the first operation 605. The order of the one or more cells may be associated with ordering the cells from highest signal quality to lowest signal quality. In some examples, the signal quality of a cell may be in accordance with a preferred quality metric. For example, if RSRP is a preferred quality metric, the order of the cells may be in accordance with the respective RSRP value of each cell. Therefore, the client device 410 may determine, in accordance with latency and/or reliability conditions, which quality metric is the preferred quality metric for ordering the cells. In some examples, the client device 410 may use the cell selection preference information and/or the order to determine which cell to access for establishing a WWAN link with the network node 110.

In a third operation 615, the client device 410 may transmit, and the relay device 405 may receive, a data offload request. In some examples, the data offload request may indicate one or more capabilities of the client device 410 associated with the WWAN RAT. For example, the one or more capabilities may include one or more of one or more supported frequency bands, one or more supported bandwidths, a quantity of supported reception layers, one or more supported subcarrier spacings (SCSs), or an indication of whether an SRB is supported (such as SRB3 or some other SRBx value), among other examples. In some examples, the indication of whether an SRB is supported may indicate whether the client device 410 supports SRB and/or C-plane signaling via a WWAN link with the network node 110.

In a fourth operation 620, the relay device 405 may transmit, and the network node 110 may receive, a sharing cell group request in accordance with the data offload request. For example, the sharing cell group request may indicate a request for the network node 110 to establish a sharing cell group (such as sharing cell group 525) for connection between the network node 110 and the client device 410 for the WWAN RAT. In some examples, the sharing cell group request may include and/or indicate the one or more capabilities of the client device 410, as indicated by the data offload request received from the client device 410.

In some examples, the sharing cell group request may include and/or indicate information associated with an identifier module profile of the relay device 405 (such as the identifier module profile 420 and/or 530). For example, the information associated with the identifier module profile may include one or more of an IMSI, an authentication key (such as a Ki), a mobile station international subscriber directory number (MSISDN), a public land mobile network (PLMN) selector, one or more authentication algorithms (such as A3, A5, and A8 algorithms), a temporary mobile subscriber identity (TMSI), subscriber profile data (such as information about a data volume threshold, a roaming status, and/or service restrictions), or an access point name (APN).

In a fifth operation 625, the network node 110 may transmit, and the relay device 405 may receive, a sharing cell group configuration. In some examples, the sharing cell group configuration may include configuration information associated with the one or more capabilities of the client device 410 for the WWAN RAT. For example, the configuration information may indicate one or more settings associated with wireless communication via the sharing cell group, the one or more settings including a packet data unit (PDU) setting, a DRB setting, a PDCP setting, or an RLC setting. In some examples, the DRB setting may indicate a DRB that is specific to the sharing cell group, and for use by the client device 410 to establish and/or maintain a WWAN link with the network node 110. In some examples, the RLC setting may indicate a single RLC associated with the sharing cell group. In some examples, the sharing cell group configuration may indicate the one or more cells included in the sharing cell group (for example, according to an spCellConfig parameter). In some examples, the sharing cell group configuration may indicate synchronization information associated with the client device 410 synchronizing with the sharing cell group (for example, according to a reconfigurationWithSync parameter).

In sixth operation 630, the relay device 405 may transmit (forward), and the client device 410 may receive, the sharing cell group configuration in accordance with receiving the sharing cell group configuration from the network node 110. Therefore, the client device 410 may receive the sharing cell group configuration from the network node 110 via the relay device 405 serving as a relay.

In a seventh operation 635, and in accordance with receiving the sharing cell group configuration, the client device 410 may perform acquisition to the sharing cell group in accordance with a cell group synchronization. For example, the client device 410 may scan for SSBs transmitted by the one or more cells within the sharing cell group. The SSBs may include a PSS, an SSS, and a PBCH. The PSS and SSS may enable the client device 410 to synchronize to the frame timing and slot timing of a target cell, and the PBCH may provide additional system information associated with facilitating communication (including timing alignment parameters and a numerology of the cell). In some examples, the client device 410 may monitor for an SSB associated with a cell determined to have the highest preference, in accordance with the cell selection preference information. For example, the client device 410 may determine the cell associated with the highest preference to be a target cell.

In accordance with detecting the SSB of the target cell, the client device 410 may perform time synchronization with the target cell, aligning the internal clock of the client device 410 to match the timing of the target cell radio frames. Concurrently, the client device 410 may additionally align with the carrier frequency of the target cell, correcting for any frequency offset that may be present due to differences between a local oscillator of the client device 410 and a cell frequency reference. In accordance with synchronizing with the SSB, the client device 410 may decode a master information block (MIB) from the PBCH. The MIB may provide basic system information such as the system bandwidth, SCS, and the scheduling of subsequent system information blocks (SIBs). In some examples, the client device 410 may additionally decode SIBs that provide information associated with the target cell configuration, such as random access parameters (which the client device 410 may use to perform a RACH procedure).

In an eighth operation 640, the client device 410 may perform a RACH procedure in accordance with successful synchronization to the target cell of the sharing cell group. In some examples, the RACH procedure may be contention-based. The client device 410 may initiate a contention-based RACH procedure if the network node 110 has not pre-assigned a specific preamble to the client device 410. In the contention based RACH procedure, the client device 410 selects a preamble from a set of preambles provided by the network node 110 and transmits the selected preamble. Because multiple client devices might choose the same preamble, which may lead to potential collisions, the network node 110 may respond with a random access response (RAR), and client devices that transmitted the same preamble may attempt to identify themselves using a temporary identifier. If there is a collision, one of the client devices may restart the contention-based RACH procedure. In some examples, the network node 110 may transmit the set of preambles used for the contention-based RACH procedure as part of the sharing cell group configuration or as part of different control signaling (such as RRC signaling).

In some examples, the RACH procedure may be contention-free. For example, the client device 410 may use a contention-free RACH procedure if the network node 110 assigns a specific preamble to a client device 410. Therefore, the client device 410 uses the preamble assigned by the network node 110 when transmitting a PRACH. In accordance with the assigned preamble being unique to the client device 410, no collisions may occur with respect to the unique preamble, and the network node 110 responds directly to the assigned preamble with an RAR. In some examples, the network node 110 may transmit the preamble used for a contention-free RACH procedure as part of the sharing cell group configuration or as part of different control signaling (such as RRC signaling).

In some examples, there may be variations in the quantity of steps in a RACH procedure performed by the client device 410 and network node 110. For example, the client device 410 may perform a 2-step RACH for faster access and reduced latency, making 2-step RACH suitable for delay-sensitive applications. The first step of the 2-step RACH may combine the preamble and the message containing information associated with the client device 410 (such as the RRC setup request) into a single transmission (called MsgA). Therefore, network node 110 may respond with a MsgB, which includes the RAR and scheduling information. The 2-step RACH procedure may reduce signaling overhead by reducing the quantity of messages communicated.

In accordance with a 4-step RACH, the client device 410 may initiate the RACH procedure by transmitting a random access preamble, followed by an RAR response from the network node 110. In reply to the RAR response, the client device 410 may transmit a message to the network, such as an RRC connection request, and the network completes the process by transmitting a contention resolution message. The client device 410 and network node 110 may operate in accordance with a 4-step RACH procedure to improve reliability of wireless communications (such as when signal conditions are below a threshold).

In accordance with performing the eighth operation 640, the network node 110 and the client device 410 may establish a wireless connection via a WWAN link associated with communications via the sharing cell group.

In a ninth operation 645, the network node 110 may transmit, and the client device 410 may receive, a capability request (such as a client device capability enquiry). In some examples, the network node 110 may transmit the capability request in accordance with successful completion of the RACH procedure. In some examples, the capability request may include a request for the client device 410 to indicate a component carrier (CC) group support. For example, the capability request may include a request for the client device 410 to indicate whether the client device 410 is capable of one or more operations in accordance with CC group support, including one or more of support for aggregation of multiple CCs as a group, support of carrier aggregation, or support for enhanced data rates associated with combining the bandwidth of multiple CCs.

In a tenth operation 650, the client device 410 may transmit, and the network node 110 may receive, capability information as a reply to the capability request. For example, the capability information may indicate CC group support associated with the client device 410. That is, the capability information may indicate whether the client device 410 is capable of one or more operations in accordance with CC group support.

In an eleventh operation 655, the network node 110 may transmit, and the client device 410 may receive, a reconfiguration message in accordance with the capability information. For example, the reconfiguration message may indicate the addition of one or more CCs to the sharing cell group in accordance with the capability information. In some examples, the addition of one or more CCs may increase data throughput for the communications via the sharing cell group, which may increase the QoS between the network node 110 and the client device 410.

In a twelfth operation 660, the client device 410 may transmit, and the network node 110 may receive, a reconfiguration complete message in reply to the reconfiguration message. For example, the reconfiguration complete message may acknowledge that the client device 410 has successfully reconfigured wireless communications via the sharing cell group to include the one or more CCs indicated in the reconfiguration message. Therefore, the network node 110 and client device 410 may directly communicate via the WWAN link user data or user data and control signaling. Further description of direct communications of user data and/or control signaling via the direct WWAN link is provided herein, including with reference to FIG. 7.

In some examples, the relay device 405 may serve as a bridge to facilitate one or more communications between the network node 110 and the client device 410 described herein. For example, the relay device 405 may relay control signaling between the client device 410 and network node 110 (such as RRC, MAC, UCI, and/or DCI). The relay device 405 may relay one or more control messages in example 600, including one or more messages of the RACH procedure, the capability request, the capability information, the reconfiguration message, and/or the reconfiguration complete message. The relay device 405 may operate as a relay for control signaling between the client device 410 and the network node 110 in accordance with a capability of the client device 410. For example, if the data offload request from the client device 410 indicates that the client device 410 does not support an SRB and/or C-plane signaling, then the relay device 405 may operate as a relay for the control signaling. If the data offload request indicates that the client device 410 supports SRB and/or C-plane signaling, then the relay device 405 may refrain from operating as a relay for the control signaling. In other words, whether control signaling is routed through the WWAN link between the network node 110 and the client device 410, or routed through the relay device 405, is in accordance with the SRB and/or C-plane signaling support of the client device 410.

FIG. 7 is a diagram illustrating an example 700 of maintaining a direct radio link between the network node 110 and client device 410 in accordance with the present disclosure. In some examples, example 700 may implement or be implemented by one or more aspects of wireless communication network 100, network node 110 architecture 200, wireless communication network 300, example 400, example 500, or example 600. For example, example 700 includes wireless communications between the network node 110, the relay device 405, and the client device 410. Additionally or alternatively, client device 410, relay device 405, and network node 110 may perform the operations of example 700 subsequent to the operations of example 600. In other words, the operations of example 700 may be associated with maintenance of the established WWAN link between the network node 110 and the client device 410. Additionally, the client device 410 and the relay device 405 may communicate via a WLAN link or WPAN link (such as the radio link 415a or the radio link 515a), the relay device 405 and the network node 110 may communicate via a WWAN link (such as the radio link 415b or the radio link 515b), and the network node 110 and the client device 410 may communicate via a WWAN link (such as the radio link 515c).

Alternative examples of the following may be implemented, where some operations are performed in a different order than described, or not described at all. In some cases, one or more operations may include additional features not mentioned below, or further operations may be added. In addition, while example 700 shows process between the network node 110, the client device 410, and the relay device 405, the communication may occur between any quantity of network devices of various types described herein.

In a first operation 705, the client device 410, the relay device 405, and/or the network node 110 may initiate an active time duration in accordance with the network node 110 and the client device 410 successfully establishing the WWAN link via the sharing cell group. In some examples, the active time duration may be a configured duration of time during which the client device 410 is enabled to communicate with network node 110 via the sharing cell group (for example, to transmit and/or receive user data, or to transmit and/or receive user data and control signaling). In other words, the active time duration indicates a duration over which the client device 410 is enabled to leverage the identifier module profile of the relay device 405 to communicate with the network node 110 via the established WWAN link.

In some examples, the relay device 405 and/or the network node 110 may configure the active time duration. For example, the relay device 405 and/or the network node 110 may transmit, and the client device 410 may receive, configuration information indicating one or more parameters associated with communications via the sharing cell group. For example, the one or more parameters may include one or more of a shared data rate associated with the sharing cell group, a data volume threshold associated with the sharing cell group, and/or the active time duration, among other examples. In some examples, the configuration information indicating the one or more parameters may be included and/or indicated via the sharing cell group configuration or via separate control signaling originating from the relay device 405 and/or the network node 110.

In a second operation 710, the client device 410 and the network node 110 may communicate one or more data messages in accordance with the established WWAN link via the sharing cell group. For example, the client device 410 may encode data information in accordance with the WWAN protocol stack and may transmit the data information (such as uplink user data) to the network node 110 via the sharing cell group. Therefore, the network node 110 may receive the data information from the client device 410 via the sharing cell group and decode the uplink client data via the WWAN protocol stack. Additionally or alternatively, the network node 110 may encode data information in accordance with the WWAN protocol stack and may transmit the data information (such as downlink client data) to the client device 410 via the sharing cell group. Therefore, the client device 410 may receive the data information from the network node 110 via the sharing cell group and decode the downlink client data via the WWAN protocol stack. By directly communicating data messages, the client device 410 and network node 110 may offload user data that would otherwise be routed through the relay device 405, which may reduce signaling overhead and power consumption at the relay device 405.

In a third operation 715, the client device 410 and the network node 110 may communicate one or more control messages.

For example, in a first scenario 715a, the client device 410 and the network node 110 may directly communicate one or more control messages in accordance with the established WWAN link via the sharing cell group. In some examples, the client device 410 and the network node 110 may communicate the one or more control messages directly if the client device 410 indicates support for SRB and/or C-plane signaling (such as indicated in the data offload request). By directly communicating control messages, the client device 410 and the network node 110 may offload signaling that would otherwise be routed through the relay device 405, which may reduce signaling overhead and power consumption at the relay device 405.

Alternatively, in a second scenario 715b, the client device 410 and the network node 110 may communicate one or more control messages via the relay device 405. In some examples, the client device 410 and the network node 110 may route the one or more control messages through the relay device 405 if the client device 410 indicates no support for SRB and/or C-plane signaling (such as indicated in the data offload request). By routing control messages through the relay device 405, the client device 410 and the network node 110 may still communicate user data via the direct WWAN link, decreasing signaling overhead and power consumption at the relay device 405.

In some examples, the network node 110 may adjust one or more QoS metrics associated with the sharing cell group directly with the client device 410 according to a channel condition associated with the sharing cell group. In some examples, the network node 110 may adjust the QoS with the client device 410 in accordance with assistance information associated with the relay device 405 and/or the client device 410. In some examples, the network node 110 may adjust the QoS with the client device 410 without the assistance information associated with the relay device 405 and/or the client device 410. In some examples, the network node 110 may determine the QoS by measuring the channel condition of the sharing cell group.

In a fourth operation 720, the client device 410, the relay device 405, and/or the network node 110 may transmit a request to restart the active time duration. In some examples, the request to restart the active time duration may occur prior to expiration of the active time duration. Additionally, the request to restart the active time duration may originate from any of the client device 410, the relay device 405, or the network node 110 (such as in cases where there is untransmitted data in the uplink and/or downlink buffer of the client device 410, relay device 405, and/or the network node 110). In some examples, the client device 410 may transmit, and the relay device 405 and/or the network node 110 may receive, the request to restart the active time duration. In some examples, the relay device 405 may transmit, and the client device 410 and/or the network node 110 may receive, the request to restart the active time duration. In some examples, the network node 110 may transmit, and the relay device 405 and/or the client device 410 may receive, the request to restart the active time duration.

In a fifth operation 725, the relay device 405 may transmit approval to restart the active time duration. In a first scenario 725a, the relay device 405 may transmit, and the client device 410 may receive, the approval to restart the active time duration. In some examples, the relay device 405 may receive the approval to restart the active timer duration from the network node 110 and may forward the indication of the approval to the client device 410. In a second scenario 725b, the relay device 405 may transmit to the network node 110 the approval to restart the active time duration. The relay device 405 may operate in accordance with the first scenario 725a and/or the second scenario 725b.

In a sixth operation 730, the client device 410 may transmit to the relay device 405 a sharing cell group status report. In some examples the sharing cell group status report may indicate one or more of a data rate associated with communications via the sharing cell group, a battery status of the client device 410, or one or more quality information values associated with the sharing cell group (such as a BLER, a packet loss rate (PLR), or a latency value). In some examples, the client device 410 may transmit the sharing cell group status report periodically. For example, the relay device 405 may transmit control signaling, or may transmit as part of the sharing cell group configuration, a periodicity value at which the client device 410 is to transmit the sharing cell group status report. In some examples, the client device 410 may transmit the sharing cell group report aperiodically (for example, in accordance with a triggering event). For example, a triggering event may include one or more of the sharing cell group being associated with a QoS value below a threshold or the battery status of the client device 410 being below a threshold. In some examples, a triggering event may include the relay device 405 transmitting and the client device 410 receiving a request for a status report associated with the direct WWAN link.

In a seventh operation 735, the client device 410, the relay device 405, and/or the network node 110 may transmit a sharing cell group termination indication that indicates termination of communications between the client device 410 and the network node 110 via the sharing cell group. Additionally, the sharing cell group termination indication may originate from any of the client device 410, the relay device 405, or the network node 110. In some examples, the client device 410 may transmit to the relay device 405 and/or the network node 110 the sharing cell group termination indication. In some examples, the relay device 405 may transmit to the client device 410 and/or the network node 110 the sharing cell group termination indication. In some examples, the network node 110 may transmit to the relay device 405 and/or the client device 410 the sharing cell group termination indication. In some examples, the client device 410, relay device 405, and/or network node 110 may transmit the sharing cell group termination indication in accordance with a triggering event. For example, the triggering event may include one or more of the active time duration expiring, a battery status of the client device 410 being below a threshold, a battery status of the relay device 405 being below a threshold, or a QoS associated with the sharing cell group being below a threshold. In some examples, the triggering event may be in accordance with one or more metrics included in the status report (such as data rate, BLER, or a buffer status report (BSR)).

FIG. 8 is a diagram illustrating an example 800 associated with resolution for failed establishment of a direct radio link between the network node 110 and client device 410, in accordance with the present disclosure. In some examples, example 800 may implement or be implemented by one or more aspects of wireless communication network 100, network node architecture 200, wireless communication network 300, example 400, example 500, example 600, or example 700. For example, example 800 includes wireless communications between the network node 110, the relay device 405. In some examples, example 800 may provide one or more operations that are alternative to aspects of the example 600 and example 700. For example, example 800 may be associated with one or more operations if the client device 410 fails to connect with the sharing cell group.

Alternative examples of the following may be implemented, where some operations are performed in a different order than described, or not described at all. In some cases, one or more operations may include additional features not mentioned below, or further operations may be added. In addition, while example 800 shows a process between the network node 110, the client device 410, and the relay device 405, the communication may occur between any quantity of network devices of various types described herein.

In a first operation 805, the client device 410 may transmit a data offload request to the relay device 405. In some examples, the data offload request may indicate one or more capabilities of the client device 410 associated with the WWAN RAT. For example, the one or more capabilities may include one or more of one or more supported frequency bands, one or more supported bandwidths, a quantity of supported reception layers, one or more supported SCSs, or an indication of whether an SRB is supported (such as SRB3 or some other SRBx value). In some examples, the indication of whether the SRB is supported may indicate whether the client device 410 supports SRB and/or C-plane signaling via a WWAN link with the network node 110.

In a second operation 810, the relay device 405 may transmit, and the network node 110 may receive, a sharing cell group request in accordance with receiving the data offload request. For example, the sharing cell group request may indicate a request for the network node 110 to establish a sharing cell group (such as sharing cell group 525, with reference to FIG. 5) for connection between the network node 110 and the client device 410 for the WWAN RAT. In some examples, the sharing cell group request may include and/or indicate the one or more capabilities of the client device 410 as indicated by the data offload request.

In some examples, the sharing cell group request may include and/or indicate information associated with an identifier module profile of the relay device 405 (such as the identifier module profile 420 and/or 530). For example, the information associated with the identifier module profile may include one or more of an IMSI, an authentication key (such as a Ki), an MSISDN, a PLMN selector, one or more authentication algorithms (such as A3, A5, and A8 algorithms), a TMSI, subscriber profile data (such as information about a data volume threshold, a roaming status, and/or service restrictions), or an APN.

In a third operation 815, the network node 110 may transmit, and the relay device 405 may receive, a sharing cell group configuration. In some examples, the sharing cell group configuration may include configuration information associated with the one or more capabilities of the client device 410 for the WWAN RAT. For

example, the configuration information may indicate one or more settings associated with wireless communication via the sharing cell group, the one or more settings including a PDU setting, a DRB setting, a PDCP setting, or a RLC setting. In some examples, the DRB setting may indicate a DRB that is specific to the sharing cell group and for use by the client device 410 to establish and/or maintain a WWAN link with the network node 110. In some examples, the RLC setting may indicate a single RLC associated with the sharing cell group.

In fourth operation 820, the relay device 405 may transmit (forward) to the client device 410 the sharing cell group configuration in accordance with receiving the sharing cell group configuration from the network node 110. Therefore, the client device 410 may receive the sharing cell group configuration from the network node 110 via the relay device 405 serving as a relay.

In a fifth operation 825, and in accordance with receiving the sharing cell group configuration, the client device 410 may attempt acquisition to the sharing cell group in accordance with a cell group synchronization. In some examples, however, as illustrated in example 800, the client device 410 may fail to synchronize with the sharing cell group. For example, the client device 410 may fail to detect a special cell (SpCell) in the sharing cell group. In some examples, an SpCell may correspond to the PCell of the cell group (or primary SCell) and may serve a role to manage the communication and coordination between the client device 410 and the network node 110. The client device 410 may fail to synchronize with the SpCell in accordance with failing to detect an SSB associated with the SpCell. Therefore, the client device 410 may fail to synchronize with the sharing cell group.

In a sixth operation 830, a RACH procedure associated with establishing a WWAN link between the network node 110 and client device 410 may fail. In some examples, the sixth operation 830 may be an alternative to the fifth operation 825. For example, the client device 410 may successfully synchronize with the sharing cell group, but the RACH procedure after the synchronization may fail. If the client device 410 does not successfully synchronize with the sharing cell group, then the client device 410 may refrain from performing the RACH procedure. The RACH procedure may fail for one or more reasons, including radio signal quality failing to satisfy a threshold, an incorrect TA, a contention resolution failure, insufficient network resources, incorrect RACH configuration parameters, or signal interference, among other examples. In accordance with the RACH procedure failure, the client device 410 may be unsuccessful in establishing a WWAN link with the network node 110.

Additionally or alternatively, to the RACH procedure failure, the client device 410 may detect an SCell group failure. For example, the SCell group included in the sharing cell group may manage the connection with one or more SCells, which may support additional data bearers, enabling improved throughput, and/or may offload data traffic from the PCell, enabling a higher throughput. An SCell group failure of the sharing cell group may occur in accordance with one or more trigger conditions, such as time expiration of an associated SCell group timer (such as t310-expiry associated with radio link failure (RLF) detection or a t312-expiry associated with failure to resolve a detected RLF), a synchronization reconfiguration failure (for example, indicated by a synchReconfigFailure-SCG parameter, which may be triggered when initial synchronization with the SCell group fails), a random access failure (for example, indicated by a randomAccessProblem parameter, which may be triggered when a random access process associated with the SCell group fails), a quantity of retransmissions satisfying a threshold (for example, indicated by an rlc-MaxNumRetx parameter when the maximum number of retransmissions has been reached), an SRB integrity failure (for example, indicated by an srb3-IntegretyFailure parameter, which may be triggered when SRB3 integrity fails), or an SCell group reconfiguration failure (for example, indicated by an scg-reconfigFailure parameter, which may be triggered when a reconfiguration message for the SCell group is not compatible with the client device 410).

Therefore, one or more of the fifth operation 825, the sixth operation 830, or the SCell group failure may result in a failure between the client device 410 and the network node 110 to establish a WWAN link in accordance with the sharing cell group.

In a seventh operation 835, the client device 410 may initiate a cool down timer in accordance with failing to establish the WWAN link with the network node 110. For example, the cool down timer may be associated with a duration of time that the client device 410 may wait before reattempting to establish a WWAN link with the network node 110. In some examples, the client device 410 may receive an indication of the cool down timer from the network node 110 and/or the relay device 405 (such as part of the sharing cell group configuration or separate control signaling). In some examples, the cool down timer may be defined in a wireless communication standard. By operating in accordance with the cool down timer, the client device 410 may refrain from continuously attempting to establish the WWAN link with network node 110 via sharing cell group, which may reduce signaling overhead and reduce power consumption.

In an eighth operation 840, the client device 410 may transmit to the relay device 405, a sharing cell group configuration failure indication in accordance with failing to establish the WWAN link with the network node 110. In some examples, the sharing cell group configuration failure indication may indicate one or more reasons why the sharing cell group configuration failed, as described herein.

In a ninth operation 845, the relay device 405 may transmit (forward) the sharing cell group configuration failure indication to the network node 110. In some examples, the sharing cell group configuration failure indication may enable the network node 110 to reconfigure the sharing cell group to reduce the likelihood of a subsequent sharing cell group configuration failure. Therefore, the sharing cell group configuration failure indication may enable the client device 410 and network node 110 to increase the reliability of establishing and maintaining a WWAN link via the sharing cell group.

In a tenth operation 850, the client device 410 may retransmit the data offload request to the relay device 405 (such as a retransmission of the data offload request from the first operation 805) in accordance with (after) the cool down timer expiring. In some examples, the retransmission of the data offload request may indicate the one or more capabilities of the client device 410 associated with the WWAN RAT.

In some examples, the relay device 405 may retransmit the sharing cell group request to the network node 110 in accordance with receiving the retransmission of the data offload request. Therefore, the network node 110 may transmit, to the relay device 405, an updated sharing cell group configuration. For example, the update sharing cell group configuration may be configured differently from the previous sharing cell group configuration (for example, the sharing cell group configuration indicated in the third operation 815) to account for the reasons why the initial sharing cell group configuration failed. Therefore, the client device 410 may proceed with one or more operations of example 600 and/or example 700 to establish and maintain the WWAN link with the network node 110 via the sharing cell group.

FIG. 9 is a flowchart illustrating an example process 900 performed, for example, at a UE or an apparatus of a UE that supports data offload from a relay device in accordance with the present disclosure. Example process 900 is an example where the apparatus or the UE (for example, UE 120e or client device 410) performs operations associated with data offload of a relay device.

As shown in FIG. 9, in some aspects, process 900 may include transmitting, to a relay wireless communication device and via a first RAT, information indicating one or more capabilities associated with a second RAT (block 910). For example, the UE (such as by using communication manager 150 or transmission component 1204, depicted in FIG. 12) may transmit, to a relay wireless communication device and via a first RAT, information indicating one or more capabilities associated with a second RAT, as described above.

As further shown in FIG. 9, in some aspects, process 900 may include receiving, from the relay wireless communication device and via the first RAT, configuration information for a cell group associated with a network node, the configuration information being associated with the one or more capabilities associated with the second RAT (block 920). For example, the UE (such as by using communication manager 150 or reception component 1202, depicted in FIG. 12 may receive, from the relay wireless communication device and via the first RAT, configuration information for a cell group associated with a network node, the configuration information being associated with the one or more capabilities associated with the second RAT, as described above.

As further shown in FIG. 9, in some aspects, process 900 may include transmitting, to the network node and via the second RAT, a request to establish a connection with the network node for the second RAT in accordance with the configuration information (block 930). For example, the UE (such as by using communication manager 150 or transmission component 1204, depicted in FIG. 12 may transmit, to the network node and via the second RAT, a request to establish a connection with the network node for the second RAT in accordance with the configuration information, as described above.

Process 900 may include additional aspects, such as any single aspect or any combination of aspects described below or in connection with one or more other processes described elsewhere herein.

In a first additional aspect, the one or more capabilities associated with the second RAT include one or more of one or more supported frequency bands, one or more supported bandwidths, a quantity of supported reception layers, one or more supported SCSs, or an indication of whether an SRB is supported.

In a second additional aspect, alone or in combination with the first aspect, the cell group operates in accordance with an identifier module profile of the relay wireless communication device.

In a third additional aspect, alone or in combination with one or more of the first and second aspects, process 900 includes receiving, in accordance with the request to establish the connection, a capability request for CC group support, and transmitting capability information indicating CC group support in accordance with receiving the capability request.

In a fourth additional aspect, alone or in combination with one or more of the first through third aspects, process 900 includes receiving a reconfiguration message that indicates an addition of one or more CCs to the cell group in accordance with the capability information, and transmitting a reconfiguration complete message in accordance with receiving the reconfiguration message.

In a fifth additional aspect, alone or in combination with one or more of the first through fourth aspects, process 900 includes communicating, with the network node and via the second RAT, one or more data messages in accordance with successfully establishing the connection with the network node for the second RAT.

In a sixth additional aspect, alone or in combination with one or more of the first through fifth aspects, process 900 includes communicating, with the network node and via the second RAT, one or more control messages in accordance with successfully establishing the connection with the network node for the second RAT and in accordance with the client wireless communication device supporting an SRB.

In a seventh additional aspect, alone or in combination with one or more of the first through sixth aspects, process 900 includes communicating, with the network node via the relay wireless communication device, one or more control messages in accordance with the client wireless communication device not supporting an SRB.

In an eighth additional aspect, alone or in combination with one or more of the first through seventh aspects, process 900 includes performing, prior to transmission of the information indicating the one or more capabilities associated with the second RAT, signal quality measurements of one or more cells associated with the network node, and storing cell selection preference information ordering the one or more cells in accordance with the signal quality measurements.

In a ninth additional aspect, alone or in combination with one or more of the first through eighth aspects, process 900 includes initiating a timer in accordance with a failure to establish the connection with the network node, transmitting, to the relay wireless communication device and via the first RAT, a cell group configuration failure indication that indicates the failure to establish the connection, and transmitting, to the relay wireless communication device and via the first RAT, a retransmission of the information indicating the one or more capabilities associated with the second RAT in accordance with expiration of the timer.

In a tenth additional aspect, alone or in combination with one or more of the first through ninth aspects, the failure to establish the connection is associated with a failure to detect a cell of the cell group, in accordance with a RACH failure, or in accordance with another connection failure between the client wireless communication device and the network node.

In an eleventh additional aspect, alone or in combination with one or more of the first through tenth aspects, the configuration information for the cell group indicates one or more parameters for wireless communications associated with the cell group, the one or more parameters including one or more of a shared data rate, a volume of data, or an active time duration associated with wireless communications via the cell group.

In a twelfth additional aspect, alone or in combination with one or more of the first through eleventh aspects, process 900 includes initiating an active time duration in accordance with successfully establishing the connection, and communicating, with one or more of the relay wireless communication device or the network node, a request to restart the active time duration prior to expiration of the active time duration.

In a thirteenth additional aspect, alone or in combination with one or more of the first through twelfth aspects, process 900 includes receiving, from the relay wireless communication device, an indication for approval to restart the active time duration.

In a fourteenth additional aspect, alone or in combination with one or more of the first through thirteenth aspects, the request to restart the active time duration originates from the client wireless communication device, the relay wireless communication device, or the network node.

In a fifteenth additional aspect, alone or in combination with one or more of the first through fourteenth aspects, process 900 includes communicating, with one or more of the relay wireless communication device or the network node, a cell group termination indication that indicates a termination of the connection with the network node for the second RAT.

In a sixteenth additional aspect, alone or in combination with one or more of the first through fifteenth aspects, the cell group termination indication originates from the client wireless communication device, the relay wireless communication device, or the network node.

In a seventeenth additional aspect, alone or in combination with one or more of the first through sixteenth aspects, process 900 includes transmitting, to the relay wireless communication device, a cell group status report that indicates a status of the connection with the network node for the second RAT.

In an eighteenth additional aspect, alone or in combination with one or more of the first through seventeenth aspects, transmission of the cell group status report is periodic or aperiodic.

In a nineteenth additional aspect, alone or in combination with one or more of the first through eighteenth aspects, the cell group status report indicates one or more of a data rate associated with the connection, a battery status of the client wireless communication device, or one or more quality parameters associated with the connection.

In a twentieth additional aspect, alone or in combination with one or more of the first through nineteenth aspects, the first RAT is a WLAN RAT and the second RAT is a WWAN RAT.

In a twenty-first additional aspect, alone or in combination with one or more of the first through twentieth aspects, a first radio link between the client wireless communication device and the relay wireless communication device is one of a WLAN link, a WPAN link, or a D2D link, and a second radio link between the client wireless communication device and the network node is a WWAN link.

In a twenty-second additional aspect, alone or in combination with one or more of the first through twenty-first aspects, the configuration information for the cell group indicates one or more settings associated with wireless communication via the cell group, the one or more settings including a PDU setting, a DRB setting, a PDCP setting, or an RLC setting.

In a twenty-third additional aspect, alone or in combination with one or more of the first through twenty-second aspects, the request to establish the connection with the network node for the second RAT is part of a RACH procedure.

In a twenty-fourth additional aspect, alone or in combination with one or more of the first through twenty-third aspects, process 900 includes receiving, from the client wireless communication device, a cell group status report that indicates a status of the connection with the network node for the second RAT.

In a twenty-fifth additional aspect, alone or in combination with one or more of the first through twenty-fourth aspects, reception of the cell group status report is periodic or aperiodic.

In a twenty-sixth additional aspect, alone or in combination with one or more of the first through twenty-fifth aspects, the cell group status report indicates one or more of a data rate associated with the connection, a battery status of the client wireless communication device, or one or more quality parameters associated with the connection.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a UE or an apparatus of a UE that supports data offload to a client device in accordance with the present disclosure. Example process 1000 is an example where the apparatus or the UE (for example, UE 120d or relay device 405) performs operations associated with data offload of a relay device.

As shown in FIG. 10, in some aspects, process 1000 may include receiving, from a client wireless communication device and via a first RAT, information indicating one or more capabilities associated with a second RAT (block 1010). For example, the UE (such as by using communication manager 150 or reception component 1202, depicted in FIG. 12) may receive, from a client wireless communication device and via a first RAT, information indicating one or more capabilities associated with a second RAT, as described above.

As further shown in FIG. 10, in some aspects, process 1000 may include transmitting, to a network node and via the second RAT, a cell group request indicating a request for the network node to establish a cell group for connection between the client wireless communication device and the network node for the second RAT, the cell group request including the one or more capabilities associated with the second RAT (block 1020). For example, the UE (such as by using communication manager 150 or transmission component 1204, depicted in FIG. 12) may transmit, to a network node and via the second RAT, a cell group request indicating a request for the network node to establish a cell group for connection between the client wireless communication device and the network node for the second RAT, the cell group request including the one or more capabilities associated with the second RAT, as described above.

As further shown in FIG. 10, in some aspects, process 1000 may include receiving, from the network node and via the second RAT, configuration information for the cell group, the configuration information being associated with the one or more capabilities associated with the second RAT (block 1030). For example, the UE (such as by using communication manager 150 or reception component 1202, depicted in FIG. 12) may receive, from the network node and via the second RAT, configuration information for the cell group, the configuration information being associated with the one or more capabilities associated with the second RAT, as described above.

As further shown in FIG. 10, in some aspects, process 1000 may include transmitting, to the client wireless communication device and via the first RAT, the configuration information for the cell group (block 1040). For example, the UE (such as by using communication manager 150 or transmission component 1204, depicted in FIG. 12) may transmit, to the client wireless communication device and via the first RAT, the configuration information for the cell group, as described above.

Process 1000 may include additional aspects, such as any single aspect or any combination of aspects described below or in connection with one or more other processes described elsewhere herein.

In a first additional aspect, the one or more capabilities associated with the second RAT includes one or more of one or more supported frequency bands, one or more supported bandwidths, a quantity of supported reception layers, one or more supported SCSs, or an indication of whether an SRB is supported.

In a second additional aspect, alone or in combination with the first aspect, the cell group request indicates an identifier module profile of the relay wireless communication device, and the cell group operates in accordance with the identifier module profile.

In a third additional aspect, alone or in combination with one or more of the first and second aspects, process 1000 includes communicating, between the client wireless communication device and the network node, one or more control messages in accordance with the client wireless communication device not supporting an SRB.

In a fourth additional aspect, alone or in combination with one or more of the first through third aspects, process 1000 includes receiving, from the client wireless communication device and via the first RAT, a cell group configuration failure indication that indicates a failure to establish the connection with the network node, and transmitting, to the network node and via the second RAT, the cell group configuration failure indication.

In a fifth additional aspect, alone or in combination with one or more of the first through fourth aspects, the configuration information for the cell group indicates one or more parameters for wireless communications associated with the cell group, the one or more parameters including one or more of a shared data rate, a volume of data, or an active time duration associated with wireless communications via the cell group.

In a sixth additional aspect, alone or in combination with one or more of the first through fifth aspects, process 1000 includes initiating an active time duration in accordance with the client wireless communication device and the network node successfully establishing the connection, and communicating, with one or more of the client wireless communication device or the network node, a request to restart the active time duration prior to expiration of the active time duration.

In a seventh additional aspect, alone or in combination with one or more of the first through sixth aspects, process 1000 includes transmitting, to the client wireless communication device, an indication for approval to restart the active time duration.

In an eighth additional aspect, alone or in combination with one or more of the first through seventh aspects, the request to restart the active time duration originates from the client wireless communication device, the relay wireless communication device, or the network node.

In a ninth additional aspect, alone or in combination with one or more of the first through eighth aspects, process 1000 includes communicating, with one or more of the client wireless communication device or the network node, a cell group termination indication that indicates a termination of the connection between the client wireless communication device and the network node.

In a tenth additional aspect, alone or in combination with one or more of the first through ninth aspects, the cell group termination indication originates from the client wireless communication device, the relay wireless communication device, or the network node.

In an eleventh additional aspect, alone or in combination with one or more of the first through tenth aspects, the first RAT is a WLAN RAT and the second RAT is a WWAN RAT.

In a twelfth additional aspect, alone or in combination with one or more of the first through eleventh aspects, a first radio link between the client wireless communication device and the relay wireless communication device is one of WLAN link, a WPAN link, or a D2D link, and a second radio link between the relay wireless communication device and the network node is a WWAN.

In a thirteenth additional aspect, alone or in combination with one or more of the first through twelfth aspects, process 1000 includes receiving, from the client wireless communication device, a cell group status report that indicates a status of the connection with the network node for the second RAT.

In a fourteenth additional aspect, alone or in combination with one or more of the first through thirteenth aspects, reception of the cell group status report is periodic or aperiodic.

In a fifteenth additional aspect, alone or in combination with one or more of the first through fourteenth aspects, the cell group status report indicates one or more of a data rate associated with the connection, a battery status of the client wireless communication device, or one or more quality parameters associated with the connection.

In a sixteenth additional aspect, alone or in combination with one or more of the first through fifteenth aspects, the first RAT is a WLAN RAT and the second RAT is a WWAN RAT.

In a seventeenth additional aspect, alone or in combination with one or more of the first through sixteenth aspects, a first radio link between the client wireless communication device and the relay wireless communication device is one of WLAN link, a WPAN link, or a D2D link, and a second radio link between the relay wireless communication device and the network node is a WWAN.

In an eighteenth additional aspect, alone or in combination with one or more of the first through seventeenth aspects, the configuration information for the cell group indicates one or more settings associated with wireless communication via the cell group, the one or more settings including a PDU setting, a DRB setting, a PDCP setting, or an RLC setting.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports wireless communications in accordance with the present disclosure. Example process 1100 is an example where the apparatus or the network node (for example, network node 110) performs operations associated with data offload from a relay device.

As shown in FIG. 11, in some aspects, process 1100 may include receiving, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT (block 1110). For example, the network node (such as by using communication manager 150 or reception component 1302, depicted in FIG. 13) may receive, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT. As further shown in FIG. 11, in some aspects, process 1100 may include transmitting, to the relay wireless communication device and via the second RAT, configuration information for the cell group, the configuration information being associated with the one or more capabilities associated with the second RAT (block 1120). For example, the network node (such as by using communication manager 150 or transmission component 1304, depicted in FIG. 13 may transmit, to the relay wireless communication device and via the second RAT, configuration information for the cell group, the configuration information being associated with the one or more capabilities associated with the second RAT, as described above.

As further shown in FIG. 11, in some aspects, process 1100 may include receiving, from the client wireless communication device and via the second RAT, a request to establish a connection with the network node for the second RAT in accordance with the configuration information (block 1130). For example, the network node (such as by using communication manager 150 or reception component 1302, depicted in FIG. 13 may receive, from the client wireless communication device and via the second RAT, a request to establish a connection with the network node for the second RAT in accordance with the configuration information, as described above.

Process 1100 may include additional aspects, such as any single aspect or any combination of aspects described below or in connection with one or more other processes described elsewhere herein.

In a first additional aspect, the one or more capabilities associated with the second RAT includes one or more of one or more supported frequency bands, one or more supported bandwidths, a quantity of supported reception layers, one or more supported SCSs, or an indication of whether an SRB is supported.

In a second additional aspect, alone or in combination with the first aspect, the cell group request indicates an identifier module profile of the relay wireless communication device, and the cell group operates in accordance with the identifier module profile.

In a third additional aspect, alone or in combination with one or more of the first and second aspects, process 1100 includes transmitting, in accordance with the request to establish the connection, a capability request for CC group support, and receiving capability information indicating CC group support in accordance with transmitting the capability request.

In a fourth additional aspect, alone or in combination with one or more of the first through third aspects, process 1100 includes transmitting a reconfiguration message that indicates an addition of one or more CCs to the cell group in accordance with the capability information, and receiving a reconfiguration complete message in accordance with receiving the reconfiguration message.

In a fifth additional aspect, alone or in combination with one or more of the first through fourth aspects, process 1100 includes communicating, with the client wireless communication device and via the second RAT, one or more data messages in accordance with successfully establishing the connection with the network node for the second RAT.

In a sixth additional aspect, alone or in combination with one or more of the first through fifth aspects, process 1100 includes communicating, with the client wireless communication device and via the second RAT, one or more control messages in accordance with successfully establishing the connection with the network node for the second RAT and in accordance with the client wireless communication device supporting an SRB.

In a seventh additional aspect, alone or in combination with one or more of the first through sixth aspects, process 1100 includes communicating, with the client wireless communication device via the relay wireless communication device, one or more control messages in accordance with the client wireless communication device not supporting an SRB.

In an eighth additional aspect, alone or in combination with one or more of the first through seventh aspects, process 1100 includes receiving, from the relay wireless communication device and via the second RAT, a cell group configuration failure indication that indicates a failure by the client wireless communication device to establish the connection.

In a ninth additional aspect, alone or in combination with one or more of the first through eighth aspects, the configuration information for the cell group indicates one or more parameters for wireless communications associated with the cell group, the one or more parameters including one or more of a shared data rate, a volume of data, or an active time duration associated with wireless communications via the cell group.

In a tenth additional aspect, alone or in combination with one or more of the first through ninth aspects, process 1100 includes initiating an active time duration in accordance with successfully establishing the connection, and communicating, with one or more of the client wireless communication device or the relay wireless communication device, a request to restart the active time duration prior to expiration of the active time duration.

In an eleventh additional aspect, alone or in combination with one or more of the first through tenth aspects, process 1100 includes receiving, from the relay wireless communication device and via the second RAT, an indication for approval to restart the active time duration.

In a twelfth additional aspect, alone or in combination with one or more of the first through eleventh aspects, the request to restart the active time duration originates from the client wireless communication device, the relay wireless communication device, or the network node.

In a thirteenth additional aspect, alone or in combination with one or more of the first through twelfth aspects, process 1100 includes communicating, with one or more of the client wireless communication device or the relay wireless communication device, a cell group termination indication that indicates a termination of the connection with the network node for the second RAT.

In a fourteenth additional aspect, alone or in combination with one or more of the first through thirteenth aspects, the cell group termination indication originates from the client wireless communication device, the relay wireless communication device, or the network node.

In a fifteenth additional aspect, alone or in combination with one or more of the first through fourteenth aspects, a first radio link between the client wireless communication device and the network node is a first WWAN link and a second radio link between the relay wireless communication device and the network node is a second WWAN link.

In a sixteenth additional aspect, alone or in combination with one or more of the first through fifteenth aspects, the configuration information for the cell group indicates one or more settings associated with wireless communication via the cell group, the one or more settings including a PDU setting, a DRB setting, a PDCP setting, or an RLC setting.

In a seventeenth additional aspect, alone or in combination with one or more of the first through sixteenth aspects, the request to establish the connection with the network node for the second RAT is part of a RACH procedure.

In an eighteenth additional aspect, alone or in combination with one or more of the first through seventeenth aspects, process 1100 includes adjusting a QoS metric associated with the connection with the network node in accordance with channel condition information of the cell group.

In a nineteenth additional aspect, alone or in combination with one or more of the first through eighteenth aspects, adjusting the QoS metric is in accordance with assistance information associated with one or more of the client wireless communication device or the relay wireless communication device.

In a twentieth additional aspect, alone or in combination with one or more of the first through nineteenth aspects, adjusting the QoS metric is independent of assistance information associated with one or more of the client wireless communication device or the relay wireless communication device.

In a twenty-first additional aspect, alone or in combination with one or more of the first through twentieth aspects, process 1100 includes performing channel condition measurements associated with one or more cells of the cell group, wherein the channel condition information of the cell group includes the channel condition measurements.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports data offload from a relay device in accordance with the present disclosure. The apparatus 1200 may be a UE, a client device, or a relay device, or a UE, client device, or relay device may include the apparatus 1200. In some aspects, the apparatus 1200 includes a reception component 1202, a transmission component 1204, and a communication manager 1206, which may be in communication with one another (for example, via one or more buses). As shown, the apparatus 1200 may communicate with another apparatus 1208 (such as a UE 120, a network node 110, or another wireless communication device, such as a client device 410 or a relay device 405) using the reception component 1202 and the transmission component 1204. The communication manager 1206 may be included in, or implemented via, a processing system (for example, the processing system 140). In some aspects, the communication manager 1206 is the communication manager 150.

In some aspects, the apparatus 1200 may be configured to and/or operable to perform one or more operations described herein in connection with FIGS. 5 through 8. Additionally or alternatively, the apparatus 1200 may be configured to and/or operable to perform one or more processes described herein, such as process 900 of FIG. 9 and/or process 1000 of FIG. 10.

The reception component 1202 may receive communications, such as reference signals, control information, and/or data communications, from the apparatus 1208. The reception component 1202 may provide received communications to one or more other components of the apparatus 1200, such as the communication manager 1206. In some aspects, the reception component 1202 may perform signal processing on the received communications, and may provide the processed signals to the one or more other components in a similar manner as described above in connection with FIG. 1. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, and/or data communications, to the apparatus 1208. In some aspects, the communication manager 1206 may generate communications and may transmit the generated communications to the transmission component 1204 for transmission to the apparatus 1208. In some aspects, the transmission component 1204 may perform signal processing on the generated communications, and may transmit the processed signals to the apparatus 1208 in a similar manner as described above in connection with FIG. 1. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE. In some aspects, the transmission component 1204 may be co-located with the reception component 1202.

The communication manager 1206 may transmit or may cause the transmission component 1204 to transmit, to a relay wireless communication device and via a first RAT, information indicating one or more capabilities associated with a second RAT. The communication manager 1206 may receive or may cause the reception component 1202 to receive, from the relay wireless communication device and via the first RAT, configuration information for a cell group associated with a network node, the configuration information being associated with the one or more capabilities associated with the second RAT. The communication manager 1206 may transmit or may cause the transmission component 1204 to transmit, to the network node and via the second RAT, a request to establish a connection with the network node for the second RAT in accordance with the configuration information. In some aspects, the communication manager 1206 may perform one or more operations described elsewhere herein as being performed by one or more components of the communication manager 1206.

The communication manager 1206 may receive or may cause the reception component 1202 to receive, from a client wireless communication device and via a first RAT, information indicating one or more capabilities associated with a second RAT. The communication manager 1206 may transmit or may cause the transmission component 1204 to transmit, to a network node and via the second RAT, a cell group request indicating a request for the network node to establish a cell group for connection between the client wireless communication device and the network node for the second RAT, the cell group request including the one or more capabilities associated with the second RAT. The communication manager 1206 may receive or may cause the reception component 1202 to receive, from the network node and via the second RAT, configuration information for the cell group, the configuration information being associated with the one or more capabilities associated with the second RAT. The communication manager 1206 may transmit or may cause the transmission component 1204 to transmit, to the client wireless communication device and via the first RAT, the configuration information for the cell group. In some aspects, the communication manager 1206 may perform one or more operations described elsewhere herein as being performed by one or more components of the communication manager 1206.

In some aspects, the communication manager 1206 includes a set of components, such as a measurement component 1210, a storage component 1212, and/or a timer component 1214. Alternatively, the set of components may be separate and distinct from the communication manager 1206. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1204 may transmit, to a relay wireless communication device and via a first RAT, information indicating one or more capabilities associated with a second RAT. The reception component 1202 may receive, from the relay wireless communication device and via the first RAT, configuration information for a cell group associated with a network node, the configuration information being associated with the one or more capabilities associated with the second RAT. The transmission component 1204 may transmit, to the network node and via the second RAT, a request to establish a connection with the network node for the second RAT in accordance with the configuration information.

The reception component 1202 may receive, in accordance with the request to establish the connection, a capability request for CC group support.

The transmission component 1204 may transmit capability information indicating CC group support in accordance with receiving the capability request.

The reception component 1202 may receive a reconfiguration message that indicates an addition of one or more CCs to the cell group in accordance with the capability information.

The transmission component 1204 may transmit a reconfiguration complete message in accordance with receiving the reconfiguration message.

The reception component 1202 and/or the transmission component 1204 may communicate, with the network node and via the second RAT, one or more data messages in accordance with successfully establishing the connection with the network node for the second RAT.

The reception component 1202 and/or the transmission component 1204 may communicate, with the network node and via the second RAT, one or more control messages in accordance with successfully establishing the connection with the network node for the second RAT and in accordance with the client wireless communication device supporting an SRB.

The reception component 1202 and/or the transmission component 1204 may communicate, with the network node via the relay wireless communication device, one or more control messages in accordance with the client wireless communication device not supporting an SRB.

The measurement component 1210 may perform, prior to transmission of the information indicating the one or more capabilities associated with the second RAT, signal quality measurements of one or more cells associated with the network node.

The storage component 1212 may store cell selection preference information ordering the one or more cells in accordance with the signal quality measurements.

The timer component 1214 may initiate a timer in accordance with a failure to establish the connection with the network node.

The transmission component 1204 may transmit, to the relay wireless communication device and via the first RAT, a cell group configuration failure indication that indicates the failure to establish the connection.

The transmission component 1204 may transmit, to the relay wireless communication device and via the first RAT, a retransmission of the information indicating the one or more capabilities associated with the second RAT in accordance with expiration of the timer.

The timer component 1214 may initiate an active time duration in accordance with successfully establishing the connection.

The reception component 1202 and/or the transmission component 1204 may communicate, with one or more of the relay wireless communication device or the network node, a request to restart the active time duration prior to expiration of the active time duration.

The reception component 1202 may receive, from the relay wireless communication device, an indication for approval to restart the active time duration.

The reception component 1202 and/or the transmission component 1204 may communicate, with one or more of the relay wireless communication device or the network node, a cell group termination indication that indicates a termination of the connection with the network node for the second RAT.

The transmission component 1204 may transmit, to the relay wireless communication device, a cell group status report that indicates a status of the connection with the network node for the second RAT.

The reception component 1202 may receive, from a client wireless communication device and via a first RAT, information indicating one or more capabilities associated with a second RAT. The transmission component 1204 may transmit, to a network node and via the second RAT, a cell group request indicating a request for the network node to establish a cell group for connection between the client wireless communication device and the network node for the second RAT, the cell group request including the one or more capabilities associated with the second RAT. The reception component 1202 may receive, from the network node and via the second RAT, configuration information for the cell group, the configuration information being associated with the one or more capabilities associated with the second RAT. The transmission component 1204 may transmit, to the client wireless communication device and via the first RAT, the configuration information for the cell group.

The reception component 1202 and/or the transmission component 1204 may communicate, between the client wireless communication device and the network node, one or more control messages in accordance with the client wireless communication device not supporting an SRB.

The reception component 1202 may receive, from the client wireless communication device and via the first RAT, a cell group configuration failure indication that indicates a failure to establish the connection with the network node.

The transmission component 1204 may transmit, to the network node and via the second RAT, the cell group configuration failure indication.

The timer component 1214 may initiate an active time duration in accordance with the client wireless communication device and the network node successfully establishing the connection.

The reception component 1202 and/or the transmission component 1204 may communicate, with one or more of the client wireless communication device or the network node, a request to restart the active time duration prior to expiration of the active time duration.

The transmission component 1204 may transmit, to the client wireless communication device, an indication for approval to restart the active time duration.

The reception component 1202 and/or the transmission component 1204 may communicate, with one or more of the client wireless communication device or the network node, a cell group termination indication that indicates a termination of the connection between the client wireless communication device and the network node.

The reception component 1202 may receive, from the client wireless communication device, a cell group status report that indicates a status of the connection with the network node for the second RAT.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports data offload from a relay device in accordance with the present disclosure. The apparatus 1300 may be a network node, or a network node may include the apparatus 1300. In some aspects, the apparatus 1300 includes a reception component 1302, a transmission component 1304, and a communication manager 1306, which may be in communication with one another (for example, via one or more buses). As shown, the apparatus 1300 may communicate with another apparatus 1308 (such as a UE 120, a network node 110, or another wireless communication device) using the reception component 1302 and the transmission component 1304. The communication manager 1306 may be included in, or implemented via, a processing system (for example, the processing system 145). In some aspects, the communication manager 1306 is the communication manager 155.

In some aspects, the apparatus 1300 may be configured to and/or operable to perform one or more operations described herein in connection with FIGS. 5 through 8. Additionally or alternatively, the apparatus 1300 may be configured to and/or operable to perform one or more processes described herein, such as process 1100 of FIG. 11.

The reception component 1302 may receive communications, such as reference signals, control information, and/or data communications, from the apparatus 1308. The reception component 1302 may provide received communications to one or more other components of the apparatus 1300, such as the communication manager 1306. In some aspects, the reception component 1302 may perform signal processing on the received communications, and may provide the processed signals to the one or more other components in a similar manner as described above in connection with FIG. 1. In some aspects, the reception component 1302 may include one or more components of the network node described above in connection with FIG. 1, such as a radio, one or more RF chains, one or more transceivers, or one or more modems, each of which may in turn be coupled with one or more antennas of the network node.

The transmission component 1304 may transmit communications, such as reference signals, control information, and/or data communications, to the apparatus 1308. In some aspects, the communication manager 1306 may generate communications and may transmit the generated communications to the transmission component 1304 for transmission to the apparatus 1308. In some aspects, the transmission component 1304 may perform signal processing on the generated communications, and may transmit the processed signals to the apparatus 1308 in a similar manner as described above in connection with FIG. 1. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node. In some aspects, the transmission component 1304 may be co-located with the reception component 1302.

The communication manager 1306 may receive or may cause the reception component 1302 to receive, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT transmitting, to the relay wireless communication device and via the second RAT, configuration information for the cell group, the configuration information being associated with the one or more capabilities associated with the second RAT. The communication manager 1306 may receive or may cause the reception component 1302 to receive, from the client wireless communication device and via the second RAT, a request to establish a connection with the network node for the second RAT in accordance with the configuration information. In some aspects, the communication manager 1306 may perform one or more operations described elsewhere herein as being performed by one or more components of the communication manager 1306.

In some aspects, the communication manager 1306 includes a set of components, such as a timer component 1310, an adjustment component 1312, and/or a measurement component 1314. Alternatively, the set of components may be separate and distinct from the communication manager 1306. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1302 may receive, from a relay wireless communication device and via a second RAT, a cell group request indicating a request for the network node to establish a cell group for connection between a client wireless communication device and the network node for the second RAT, the cell group request including information of the client wireless communication device, the information indicating one or more capabilities associated with the second RAT transmitting, to the relay wireless communication device and via the second RAT, configuration information for the cell group, the configuration information being associated with the one or more capabilities associated with the second RAT. The reception component 1302 may receive, from the client wireless communication device and via the second RAT, a request to establish a connection with the network node for the second RAT in accordance with the configuration information.

The transmission component 1304 may transmit, in accordance with the request to establish the connection, a capability request for CC group support.

The reception component 1302 may receive capability information indicating CC group support in accordance with transmitting the capability request.

The transmission component 1304 may transmit a reconfiguration message that indicates an addition of one or more CCs to the cell group in accordance with the capability information.

The reception component 1302 may receive a reconfiguration complete message in accordance with receiving the reconfiguration message.

The reception component 1302 and/or the transmission component 1304 may communicate, with the client wireless communication device and via the second RAT, one or more data messages in accordance with successfully establishing the connection with the network node for the second RAT.

The reception component 1302 and/or the transmission component 1304 may communicate, with the client wireless communication device and via the second RAT, one or more control messages in accordance with successfully establishing the connection with the network node for the second RAT and in accordance with the client wireless communication device supporting an SRB.

The reception component 1302 and/or the transmission component 1304 may communicate, with the client wireless communication device via the relay wireless communication device, one or more control messages in accordance with the client wireless communication device not supporting an SRB.

The reception component 1302 may receive, from the relay wireless communication device and via the second RAT, a cell group configuration failure indication that indicates a failure by the client wireless communication device to establish the connection.

The timer component 1310 may initiate an active time duration in accordance with successfully establishing the connection.

The reception component 1302 and/or the transmission component 1304 may communicate, with one or more of the client wireless communication device or the relay wireless communication device, a request to restart the active time duration prior to expiration of the active time duration.

The reception component 1302 may receive, from the relay wireless communication device and via the second RAT, an indication for approval to restart the active time duration.

The reception component 1302 and/or the transmission component 1304 may communicate, with one or more of the client wireless communication device or the relay wireless communication device, a cell group termination indication that indicates a termination of the connection with the network node for the second RAT.

The adjustment component 1312 may adjust a QoS metric associated with the connection with the network node in accordance with channel condition information of the cell group.

The measurement component 1314 may perform channel condition measurements associated with one or more cells of the cell group, wherein the channel condition information of the cell group includes the channel condition measurements.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication by a client wireless communication device, comprising: transmitting, to a relay wireless communication device and via a first radio access technology (RAT), information indicating one or more capabilities associated with a second RAT; receiving, from the relay wireless communication device and via the first RAT, configuration information for a cell group associated with a network node, the configuration information being associated with the one or more capabilities associated with the second RAT; and transmitting, to the network node and via the second RAT, a request to establish a connection with the network node for the second RAT in accordance with the configuration information.
Aspect 2: The method of Aspect 1, wherein the one or more capabilities associated with the second RAT include one or more of: one or more supported frequency bands, one or more supported bandwidths, a quantity of supported reception layers, one or more supported subcarrier spacings (SCSs), or an indication of whether a signaling radio bearer (SRB) is supported.
Aspect 3: The method of any of Aspects 1-2, wherein the cell group operates in accordance with an identifier module profile of the relay wireless communication device.
Aspect 4: The method of any of Aspects 1-3, further comprising: receiving, in accordance with the request to establish the connection, a capability request for component carrier (CC) group support; and transmitting capability information indicating CC group support in accordance with receiving the capability request.
Aspect 5: The method of Aspect 4, further comprising: receiving a reconfiguration message that indicates an addition of one or more CCs to the cell group in accordance with the capability information; and transmitting a reconfiguration complete message in accordance with receiving the reconfiguration message.
Aspect 6: The method of any of Aspects 1-5, further comprising: communicating, with the network node and via the second RAT, one or more data messages in accordance with successfully establishing the connection with the network node for the second RAT.
Aspect 7: The method of Aspect 6, further comprising: communicating, with the network node and via the second RAT, one or more control messages in accordance with successfully establishing the connection with the network node for the second RAT and in accordance with the client wireless communication device supporting a signaling radio bearer (SRB).
Aspect 8: The method of Aspect 6, further comprising: communicating, with the network node via the relay wireless communication device, one or more control messages in accordance with the client wireless communication device not supporting a signaling radio bearer (SRB).
Aspect 9: The method of any of Aspects 1-8, further comprising: performing, prior to transmission of the information indicating the one or more capabilities associated with the second RAT, signal quality measurements of one or more cells associated with the network node; and storing cell selection preference information ordering the one or more cells in accordance with the signal quality measurements.
Aspect 10: The method of any of Aspects 1-9, further comprising: initiating a timer in accordance with a failure to establish the connection with the network node; transmitting, to the relay wireless communication device and via the first RAT, a cell group configuration failure indication that indicates the failure to establish the connection; and transmitting, to the relay wireless communication device and via the first RAT, a retransmission of the information indicating the one or more capabilities associated with the second RAT in accordance with expiration of the timer.
Aspect 11: The method of Aspect 10, wherein the failure to establish the connection is associated with a failure to detect a cell of the cell group, in accordance with a random access channel (RACH) failure, or in accordance with another connection failure between the client wireless communication device and the network node.
Aspect 12: The method of any of Aspects 1-11, wherein the configuration information for the cell group indicates one or more parameters for wireless communications associated with the cell group, the one or more parameters including one or more of a shared data rate, a volume of data, or an active time duration associated with wireless communications via the cell group.
Aspect 13: The method of any of Aspects 1-12, further comprising: initiating an active time duration in accordance with successfully establishing the connection; and communicating, with one or more of the relay wireless communication device or the network node, a request to restart the active time duration prior to expiration of the active time duration.
Aspect 14: The method of Aspect 13, further comprising: receiving, from the relay wireless communication device, an indication for approval to restart the active time duration.
Aspect 15: The method of Aspect 13, wherein the request to restart the active time duration originates from the client wireless communication device, the relay wireless communication device, or the network node.
Aspect 16: The method of any of Aspects 1-15, further comprising: communicating, with one or more of the relay wireless communication device or the network node, a cell group termination indication that indicates a termination of the connection with the network node for the second RAT.
Aspect 17: The method of Aspect 16, wherein the cell group termination indication originates from the client wireless communication device, the relay wireless communication device, or the network node.
Aspect 18: The method of any of Aspects 1-17, further comprising: transmitting, to the relay wireless communication device, a cell group status report that indicates a status of the connection with the network node for the second RAT.
Aspect 19: The method of Aspect 18, wherein transmission of the cell group status report is periodic or aperiodic.
Aspect 20: The method of Aspect 18, wherein the cell group status report indicates one or more of a data rate associated with the connection, a battery status of the client wireless communication device, or one or more quality parameters associated with the connection.
Aspect 21: The method of any of Aspects 1-20, wherein the first RAT is a wireless local area network (WLAN) RAT and the second RAT is a wireless wide area network (WWAN) RAT.
Aspect 22: The method of any of Aspects 1-21, wherein a first radio link between the client wireless communication device and the relay wireless communication device is one of a wireless local area network (WLAN) link, a wireless personal area network (WPAN) link, or a device to device (D2D) link, and a second radio link between the client wireless communication device and the network node is a wireless wide area network (WWAN) link.
Aspect 23: The method of any of Aspects 1-22, wherein the configuration information for the cell group indicates one or more settings associated with wireless communication via the cell group, the one or more settings including a packet data unit (PDU) setting, a data radio bearer (DRB) setting, a packet data convergence protocol (PDCP) setting, or a radio link control (RLC) setting.
Aspect 24: The method of any of Aspects 1-23, wherein the request to establish the connection with the network node for the second RAT is part of a random access channel (RACH) procedure.
Aspect 25: A method of wireless communication by a relay wireless communication device, comprising: receiving, from a client wireless communication device and via a first radio access technology (RAT), information indicating one or more capabilities associated with a second RAT; transmitting, to a network node and via the second RAT, a cell group request indicating a request for the network node to establish a cell group for connection between the client wireless communication device and the network node for the second RAT, the cell group request including the one or more capabilities associated with the second RAT; receiving, from the network node and via the second RAT, configuration information for the cell group, the configuration information being associated with the one or more capabilities associated with the second RAT; and transmitting, to the client wireless communication device and via the first RAT, the configuration information for the cell group.
Aspect 26: The method of Aspect 25, wherein the one or more capabilities associated with the second RAT includes one or more of: one or more supported frequency bands, one or more supported bandwidths, a quantity of supported reception layers, one or more supported subcarrier spacings (SCSs), or an indication of whether a signaling radio bearer (SRB) is supported.
Aspect 27: The method of any of Aspects 25-26, wherein the cell group request indicates an identifier module profile of the relay wireless communication device, and wherein the cell group operates in accordance with the identifier module profile.
Aspect 28: The method of any of Aspects 25-27, further comprising: communicating, between the client wireless communication device and the network node, one or more control messages in accordance with the client wireless communication device not supporting a signaling radio bearer (SRB).
Aspect 29: The method of any of Aspects 25-28, further comprising: receiving, from the client wireless communication device and via the first RAT, a cell group configuration failure indication that indicates a failure to establish the connection with the network node; and transmitting, to the network node and via the second RAT, the cell group configuration failure indication.
Aspect 30: The method of any of Aspects 25-29, wherein the configuration information for the cell group indicates one or more parameters for wireless communications associated with the cell group, the one or more parameters including one or more of a shared data rate, a volume of data, or an active time duration associated with wireless communications via the cell group.
Aspect 31: The method of any of Aspects 25-30, further comprising: initiating an active time duration in accordance with the client wireless communication device and the network node successfully establishing the connection; and communicating, with one or more of the client wireless communication device or the network node, a request to restart the active time duration prior to expiration of the active time duration.
Aspect 32: The method of Aspect 31, further comprising: transmitting, to the client wireless communication device, an indication for approval to restart the active time duration.
Aspect 33: The method of Aspect 31, wherein the request to restart the active time duration originates from the client wireless communication device, the relay wireless communication device, or the network node.
Aspect 34: The method of any of Aspects 25-33, further comprising: communicating, with one or more of the client wireless communication device or the network node, a cell group termination indication that indicates a termination of the connection between the client wireless communication device and the network node.
Aspect 35: The method of Aspect 34, wherein the cell group termination indication originates from the client wireless communication device, the relay wireless communication device, or the network node.
Aspect 36: The method of Aspect 1, further comprising: receiving, from the client wireless communication device, a cell group status report that indicates a status of the connection with the network node for the second RAT.
Aspect 37: The method of Aspect 36, wherein reception of the cell group status report is periodic or aperiodic.
Aspect 38: The method of Aspect 36, wherein the cell group status report indicates one or more of a data rate associated with the connection, a battery status of the client wireless communication device, or one or more quality parameters associated with the connection.
Aspect 39: The method of any of Aspects 25-38, wherein the first RAT is a wireless local area network (WLAN) RAT and the second RAT is a wireless wide area network (WWAN) RAT.
Aspect 40: The method of any of Aspects 25-39, wherein a first radio link between the client wireless communication device and the relay wireless communication device is one of wireless local area network (WLAN) link, a wireless personal area network (WPAN) link, or a device to device (D2D) link, and a second radio link between the relay wireless communication device and the network node is a wireless wide area network (WWAN).
Aspect 41: The method of any of Aspects 25-40, wherein the configuration information for the cell group indicates one or more settings associated with wireless communication via the cell group, the one or more settings including a packet data unit (PDU) setting, a data radio bearer (DRB) setting, a packet data convergence protocol (PDCP) setting, or a radio link control (RLC) setting.
Aspect 42: A method of wireless communication by a network node, comprising: receiving, from a relay wireless communication device and via a second radio access technology (RAT), a cell group request indicating a request for the network node to establish a cell group for connection between a client wireless communication device and the network node for the second RAT, the cell group request including information of the client wireless communication device, the information indicating one or more capabilities associated with the second RAT; transmitting, to the relay wireless communication device and via the second RAT, configuration information for the cell group, the configuration information being associated with the one or more capabilities associated with the second RAT; and receiving, from the client wireless communication device and via the second RAT, a request to establish a connection with the network node for the second RAT in accordance with the configuration information;
Aspect 43: The method of Aspect 42, wherein the one or more capabilities associated with the second RAT includes one or more of: one or more supported frequency bands, one or more supported bandwidths, a quantity of supported reception layers, one or more supported subcarrier spacings (SCSs), or an indication of whether a signaling radio bearer (SRB) is supported.
Aspect 44: The method of any of Aspects 42-43, wherein the cell group request indicates an identifier module profile of the relay wireless communication device, and wherein the cell group operates in accordance with the identifier module profile.
Aspect 45: The method of any of Aspects 42-44, further comprising: transmitting, in accordance with the request to establish the connection, a capability request for component carrier (CC) group support; and receiving capability information indicating CC group support in accordance with transmitting the capability request.
Aspect 46: The method of Aspect 45, further comprising: transmitting a reconfiguration message that indicates an addition of one or more CCs to the cell group in accordance with the capability information; and receiving a reconfiguration complete message in accordance with receiving the reconfiguration message.
Aspect 47: The method of any of Aspects 42-46, further comprising: communicating, with the client wireless communication device and via the second RAT, one or more data messages in accordance with successfully establishing the connection with the network node for the second RAT.
Aspect 48: The method of Aspect 47, further comprising: communicating, with the client wireless communication device and via the second RAT, one or more control messages in accordance with successfully establishing the connection with the network node for the second RAT and in accordance with the client wireless communication device supporting a signaling radio bearer (SRB).
Aspect 49: The method of Aspect 47, further comprising: communicating, with the client wireless communication device via the relay wireless communication device, one or more control messages in accordance with the client wireless communication device not supporting a signaling radio bearer (SRB).
Aspect 50: The method of any of Aspects 42-49, further comprising: receiving, from the relay wireless communication device and via the second RAT, a cell group configuration failure indication that indicates a failure by the client wireless communication device to establish the connection.
Aspect 51: The method of any of Aspects 42-50, wherein the configuration information for the cell group indicates one or more parameters for wireless communications associated with the cell group, the one or more parameters including one or more of a shared data rate, a volume of data, or an active time duration associated with wireless communications via the cell group.
Aspect 52: The method of any of Aspects 42-51, further comprising: initiating an active time duration in accordance with successfully establishing the connection; and communicating, with one or more of the client wireless communication device or the relay wireless communication device, a request to restart the active time duration prior to expiration of the active time duration.
Aspect 53: The method of Aspect 52, further comprising: receiving, from the relay wireless communication device and via the second RAT, an indication for approval to restart the active time duration.
Aspect 54: The method of Aspect 52, wherein the request to restart the active time duration originates from the client wireless communication device, the relay wireless communication device, or the network node.
Aspect 55: The method of any of Aspects 42-54, further comprising: communicating, with one or more of the client wireless communication device or the relay wireless communication device, a cell group termination indication that indicates a termination of the connection with the network node for the second RAT.
Aspect 56: The method of Aspect 55, wherein the cell group termination indication originates from the client wireless communication device, the relay wireless communication device, or the network node.
Aspect 57: The method of any of Aspects 42-56, the second RAT is a wireless wide area network (WWAN) RAT.
Aspect 58: The method of any of Aspects 42-57, wherein a first radio link between the client wireless communication device and the network node is a first wireless wide area network (WWAN) link and a second radio link between the relay wireless communication device and the network node is a second WWAN link.
Aspect 59: The method of any of Aspects 42-58, wherein the configuration information for the cell group indicates one or more settings associated with wireless communication via the cell group, the one or more settings including a packet data unit (PDU) setting, a data radio bearer (DRB) setting, a packet data convergence protocol (PDCP) setting, or a radio link control (RLC) setting.
Aspect 60: The method of any of Aspects 42-59, wherein the request to establish the connection with the network node for the second RAT is part of a random access channel (RACH) procedure.
Aspect 61: The method of any of Aspects 42-60, further comprising: adjusting a quality of service (QoS) metric associated with the connection with the network node in accordance with channel condition information of the cell group.
Aspect 62: The method of Aspect 61, wherein adjusting the QoS metric is in accordance with assistance information associated with one or more of the client wireless communication device or the relay wireless communication device.
Aspect 63: The method of Aspect 61, wherein adjusting the QoS metric is independent of assistance information associated with one or more of the client wireless communication device or the relay wireless communication device.
Aspect 64: The method of Aspect 61, further comprising: performing channel condition measurements associated with one or more cells of the cell group, wherein the channel condition information of the cell group includes the channel condition measurements.
Aspect 65: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-64.
Aspect 66: An apparatus for wireless communication at a device, the apparatus comprising one or more memories and one or more processors coupled to the one or more memories, the one or more processors configured to cause the device to perform the method of one or more of Aspects 1-64.
Aspect 67: An apparatus for wireless communication, the apparatus comprising at least one means for performing the method of one or more of Aspects 1-64.
Aspect 68: A non-transitory computer-readable medium storing code for wireless communication, the code comprising instructions executable by one or more processors to perform the method of one or more of Aspects 1-64.
Aspect 69: A non-transitory computer-readable medium storing a set of instructions for wireless communication, the set of instructions comprising one or more instructions that, when executed by one or more processors of a device, cause the device to perform the method of one or more of Aspects 1-64.
Aspect 70: A device for wireless communication, the device comprising a processing system that includes one or more processors and one or more memories coupled with the one or more processors, the processing system configured to cause the device to perform the method of one or more of Aspects 1-64.
Aspect 71: An apparatus for wireless communication at a device, the apparatus comprising one or more memories and one or more processors coupled to the one or more memories, the one or more processors individually or collectively configured to cause the device to perform the method of one or more of Aspects 1-64.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A client wireless communication device for wireless communication, comprising:
a processing system that includes one or more processors and one or more memories coupled with the one or more processors, the processing system configured to cause the client wireless communication device to:
transmit, to a relay wireless communication device and via a first radio access technology (RAT), information indicating one or more capabilities associated with a second RAT;
receive, from the relay wireless communication device and via the first RAT, configuration information for a cell group associated with a network node, the configuration information being associated with the one or more capabilities associated with the second RAT; and
transmit, to the network node and via the second RAT, a request to establish a connection with the network node for the second RAT in accordance with the configuration information.

2. The client wireless communication device of claim 1, wherein the one or more capabilities associated with the second RAT include one or more of:
one or more supported frequency bands,
one or more supported bandwidths,
a quantity of supported reception layers,
one or more supported subcarrier spacings (SCSs), or
an indication of whether a signaling radio bearer (SRB) is supported.

3. The client wireless communication device of claim 1, wherein the cell group operates in accordance with an identifier module profile of the relay wireless communication device.

4. The client wireless communication device of claim 1, wherein the processing system is further configured to cause the client wireless communication device to:
receive, in accordance with the request to establish the connection, a capability request for component carrier (CC) group support; and
transmit capability information indicating CC group support in accordance with receiving the capability request.

5. The client wireless communication device of claim 4, wherein the processing system is further configured to cause the client wireless communication device to:
receive a reconfiguration message that indicates an addition of one or more CCs to the cell group in accordance with the capability information; and
transmit a reconfiguration complete message in accordance with receiving the reconfiguration message.

6. The client wireless communication device of claim 1, wherein the processing system is further configured to cause the client wireless communication device to:
communicate, with the network node and via the second RAT, one or more data messages in accordance with successfully establishing the connection with the network node for the second RAT.

7. The client wireless communication device of claim 6, wherein the processing system is further configured to cause the client wireless communication device to:
communicate, with the network node and via the second RAT, one or more control messages in accordance with successfully establishing the connection with the network node for the second RAT and in accordance with the client wireless communication device supporting a signaling radio bearer (SRB).

8. The client wireless communication device of claim 6, wherein the processing system is further configured to cause the client wireless communication device to:
communicate, with the network node via the relay wireless communication device, one or more control messages in accordance with the client wireless communication device not supporting a signaling radio bearer (SRB).

9. The client wireless communication device of claim 1, wherein the processing system is further configured to cause the client wireless communication device to:
perform, prior to transmission of the information indicating the one or more capabilities associated with the second RAT, signal quality measurements of one or more cells associated with the network node; and
store cell selection preference information ordering the one or more cells in accordance with the signal quality measurements.

10. The client wireless communication device of claim 1, wherein the processing system is further configured to cause the client wireless communication device to:
initiate a timer in accordance with a failure to establish the connection with the network node;
transmit, to the relay wireless communication device and via the first RAT, a cell group configuration failure indication that indicates the failure to establish the connection; and
transmit, to the relay wireless communication device and via the first RAT, a retransmission of the information indicating the one or more capabilities associated with the second RAT in accordance with expiration of the timer.

11. The client wireless communication device of claim 10, wherein the failure to establish the connection is associated with a failure to detect a cell of the cell group, in accordance with a random access channel (RACH) failure, or in accordance with another connection failure between the client wireless communication device and the network node.

12. The client wireless communication device of claim 1, wherein the configuration information for the cell group indicates one or more parameters for wireless communications associated with the cell group, the one or more parameters including one or more of a shared data rate, a volume of data, or an active time duration associated with wireless communications via the cell group.

13. The client wireless communication device of claim 1, wherein the processing system is further configured to cause the client wireless communication device to:
initiate an active time duration in accordance with successfully establishing the connection; and
communicate, with one or more of the relay wireless communication device or the network node, a request to restart the active time duration prior to expiration of the active time duration.

14. The client wireless communication device of claim 13, wherein the processing system is further configured to cause the client wireless communication device to:
receive, from the relay wireless communication device, an indication for approval to restart the active time duration.

15. The client wireless communication device of claim 13, wherein the request to restart the active time duration originates from the client wireless communication device, the relay wireless communication device, or the network node.

16. The client wireless communication device of claim 1, wherein the processing system is further configured to cause the client wireless communication device to:
communicate, with one or more of the relay wireless communication device or the network node, a cell group termination indication that indicates a termination of the connection with the network node for the second RAT.

17. The client wireless communication device of claim 16, wherein the cell group termination indication originates from the client wireless communication device, the relay wireless communication device, or the network node.

18. The client wireless communication device of claim 1, wherein the processing system is further configured to cause the client wireless communication device to:
transmit, to the relay wireless communication device, a cell group status report that indicates a status of the connection with the network node for the second RAT.

19. A method of wireless communication by a client wireless communication device, comprising:
transmitting, to a relay wireless communication device and via a first radio access technology (RAT), information indicating one or more capabilities associated with a second RAT;
receiving, from the relay wireless communication device and via the first RAT, configuration information for a cell group associated with a network node, the configuration information being associated with the one or more capabilities associated with the second RAT; and
transmitting, to the network node and via the second RAT, a request to establish a connection with the network node for the second RAT in accordance with the configuration information.

20. An apparatus for wireless communication, comprising:
means for transmitting, to a wireless communication device and via a first radio access technology (RAT), information indicating one or more capabilities associated with a second RAT;
means for receiving, from the wireless communication device and via the first RAT, configuration information for a cell group associated with a network node, the configuration information being associated with the one or more capabilities associated with the second RAT; and
means for transmitting, to the network node and via the second RAT, a request to establish a connection with the network node for the second RAT in accordance with the configuration information.
